(19) United States
(12) Patent Application Publication
(10) Pub. No.: US 2026/0225545 A1
(43) Pub. Date: Aug. 6, 2026

(54) COMMUNICATION SYSTEM, ELECTRONIC CONTROL UNIT, VEHICLE POWER STATE MANAGEMENT METHOD, AND VEHICLE POWER STATE MANAGEMENT PROGRAM

(71) Applicant: DENSO CORPORATION, Kariya-city (JP)

(72) Inventors: Mana TANAKA, Kariya-city (JP); Tomoya TOKUNAGA, Kariya-city (JP)

(21) Appl. No.: 19/461,800

(22) Filed: Jan. 28, 2026

(30) Foreign Application Priority Data
Jan. 31, 2025 (JP) 2025-015095

(51) Int. Cl. B60R 16/023

(52) U.S. Cl. CPC B60R 16/0231; B60R 16/0238

(57) ABSTRACT

A communication system mounted on a movable object is disclosed which includes a management device and an electronic control unit. The electronic control unit is started up by supply of power from an outside via a relay and to be stopped by cutoff of the power from the outside via the relay. The electronic control unit being supplied with the power is started up by switching to a wake-up state and stopped by switching to a sleep state, based on a communication frame received from the outside. At startup, the electronic control unit sets the vehicle power state in self-retaining information to undefined. Upon acquiring vehicle power state information from the management device, the electronic control unit updates the vehicle power state in the self-retaining information.

### CROSS REFERENCE TO RELATED APPLICATION

The present application claims the benefit of priority from Japanese Patent Application No. 2025-015095 filed on January 31, 2025. The entire disclosure of the above application is incorporated herein by reference.

### TECHNICAL FIELD

The present disclosure relates to a communication system, an electronic control unit, a vehicle power state management method, and a vehicle power state management program.

### BACKGROUND

A typical vehicle includes a large number of electronic control units (hereinafter referred to as ECUs) for controlling onboard devices, and a communication system is constructed by connecting these ECUs to communication buses.

### SUMMARY

According to one aspect of the present disclosure, a communication system mounted on a movable object is disclosed that includes a management device and an electronic control unit. The electronic control unit is started up by supply of power from an outside via a relay and to be stopped by cutoff of the power from the outside via the relay. The electronic control unit being supplied with the power is started up by switching to a wake-up state and stopped by switching to a sleep state, based on a communication frame received from the outside. At startup, the electronic control unit sets the vehicle power state in self-retaining information to undefined. Upon acquiring vehicle power state information from the management device, the electronic control unit updates the vehicle power state in the self-retaining information.

### BRIEF DESCRIPTION OF DRAWINGS

Objects, features and advantages of the present disclosure will become apparent from the following detailed description made with accompanying drawings. In the drawings:

FIG. 1 is a functional block diagram illustrating an overall configuration of an embodiment;

FIG. 2 is a functional block diagram illustrating a mobility computer;

FIG. 3 is a functional block diagram illustrating a power distribution management ECU;

FIG. 4 is a functional block diagram illustrating a first zone ECU;

FIG. 5 is a functional block diagram illustrating a first end ECU;

FIG. 6 is a diagram illustrating state transitions;

FIG. 7 is a flowchart illustrating startup control processing based on scenes;

FIG. 8 is a flowchart illustrating startup control processing based on scenes;

FIG. 9 is a flowchart illustrating stop control processing based on scenes;

FIG. 10 is a flowchart illustrating stop control processing based on scenes;

FIG. 11 is a diagram illustrating a management table;

FIG. 12 is a flowchart illustrating startup control processing by timeout method;

FIG. 13 is a diagram illustrating timer operation for each startup pattern;

FIG. 14 is a flowchart illustrating stop control processing by timeout method;

FIG. 15 is a diagram illustrating timer operation for each stop pattern;

FIG. 16 is a flowchart illustrating startup processing of the mobility computer;

FIG. 17 is a flowchart illustrating stop processing of the mobility computer;

FIG. 18 is a flowchart illustrating startup processing of the zone ECU;

FIG. 19 is a diagram illustrating state transitions of the mobility computer;

FIG. 20 is a diagram illustrating state transitions of the zone ECU, the power distribution management ECU, and the end ECU;

FIG. 21 is a diagram illustrating a network configuration;

FIG. 22 is a diagram illustrating a network configuration;

FIG. 23 is a diagram illustrating a network configuration;

FIG. 24 is a diagram illustrating a network configuration; and

FIG. 25 is a diagram illustrating a network configuration.

### DETAILED DESCRIPTION

A vehicle typically includes a large number of ECUs for controlling onboard devices, and a communication system is constructed by connecting these ECUs to communication buses. In this type of communication system, there is a technology for reducing power consumption of the overall system by transitioning some unnecessary ECUs from a wake-up state to a sleep state. As means for starting-up and stopping ECUs in the technology, mechanical relay control is performed for each sub-system.

In contrast to the technology using the mechanical relay control, technologies have been emerging in recent years that employ high-performance semiconductor power switches (hereinafter referred to also as IPDs (Intelligent Power Devices)), and that enable software control to provide various power states in dynamic and low power consuming fashions. Configurations employing the IPDs make it possible to perform power control on an ECU-by-ECU basis by combining startup stop control performed via a relay based on the IPD ON OFF with startup stop control performed by switching between a wake-up state and a sleep state based on communication frames. However, since the energization states of the power line for each ECU no longer correspond one-to-one with the vehicle power states representing the power states of the vehicle as a whole, it becomes necessary to distribute the vehicle power state to each ECU via communications. In such cases, issues may include how to define a state at ECU startup or under state transition from one steady state to another steady state, and how to do diagnosis management and/or application operation management at the startup and/or under the state transition.

In view of the foregoing, it is an objective of the present disclosure is to provide a communication system, an electronic control unit, a vehicle power state management method, and a vehicle power state management program that can appropriately managing vehicle power states and appropriately perform diagnosis management and application operation management at startup and/or under state transition.

According to a first aspect of the present disclosure, a communication system mounted on a movable object is provided that comprises: a management device; and an electronic control unit arranged to be communicable with the management device. The electronic control unit is configured such that: the electronic control unit is started up by supply of power from an outside of the electronic control unit via a relay and is stopped by cutoff of the power from the outside via the relay; the electronic control unit being supplied with the power is started up by switching to a wake-up state and is stopped by switching to a sleep state, based on a communication frame received from the outside; the electronic control unit retains self-retaining information of a vehicle power state; at startup, the electronic control unit sets the vehicle power state in the self-retaining information to undefined; and, upon acquiring vehicle power state information from the management device, the electronic control unit updates the vehicle power state in the self-retaining information.

According to a second aspect of the present disclosure, an electronic control unit in a communication system mounted on a movable object is provided. The electronic control unit is arranged to be communicable with a management device in the communication system and is configured such that: the electronic control unit is started up by supply of power from an outside of the electronic control unit via a relay and is stopped by cutoff of the power from the outside via the relay; the electronic control unit being supplied with the power is started up by switching to a wake-up state and is stopped by switching to a sleep state, based on a communication frame received from the outside; the electronic control unit retains self-retaining information of a vehicle power state; at startup, the electronic control unit sets the vehicle power state in the self-retaining information to undefined; and, upon acquiring vehicle power state information from the management device, the electronic control unit updates the vehicle power state in the self-retaining information.

According to a third aspect of the present disclosure, a vehicle power state management method performed in a communication system mounted on a movable object is provided. The communication system includes: a management device; and an electronic control unit arranged to be communicable with the management device. The electronic control unit being configured such that: the electronic control unit is started up by supply of power from an outside of the electronic control unit via a relay and is stopped by cutoff of the power from the outside via the relay; and the electronic control unit being supplied with the power is started up by switching to a wake-up state and is stopped by switching to a sleep state, based on a communication frame received from the outside. The vehicle power state management method comprises: at startup, setting a vehicle power state in self-retaining information to undefined; and upon acquiring vehicle power state information from the management device, updating the vehicle power state in the self-retaining information.

According to a fourth aspect of the present disclosure, a vehicle power state management program stored in a non-transitory storage medium and executable by a controller of an electronic control unit in a communication system mounted on a movable object is provided. The electronic control unit is arranged to be communicable with a management device in the communication system and is configured such that: the electronic control unit is started up by supply of power from an outside of the electronic control unit via a relay and is stopped by cutoff of the power from the outside via the relay; and the electronic control unit being supplied with the power is started up by switching to a wake-up state and is stopped by switching to a sleep state, based on a communication frame received from the outside. The vehicle power state management program causes the electronic control unit to perform: at startup, setting a vehicle power state in self-retaining information to undefined; and upon acquiring vehicle power state information from the management device, updating the vehicle power state in the self-retaining information.

According to the above configurations of the present disclosure, at startup, the electronic control unit sets the vehicle power state in the self-retaining information to the undefined, and the electronic control unit updates the vehicle power state in the self-retaining information based on the acquired vehicle power state information when acquiring such information from the management device. By setting the vehicle power state in the self-retaining information to the undefined at startup and updating the vehicle power state in the self-retaining information based on the vehicle power state information acquired from the management device, it is possible to appropriately manage the vehicle power state, enabling diagnosis management and/or application operation management at the startup and/or under state-transition.

Embodiments will be described with reference to the drawings. A communication system 1 is based on a known zone architecture and is configured to include a plurality of ECUs arranged according to zones. The zones are divisions indicating installation locations such as the front, rear, left, and right regions of the vehicle body, for example.

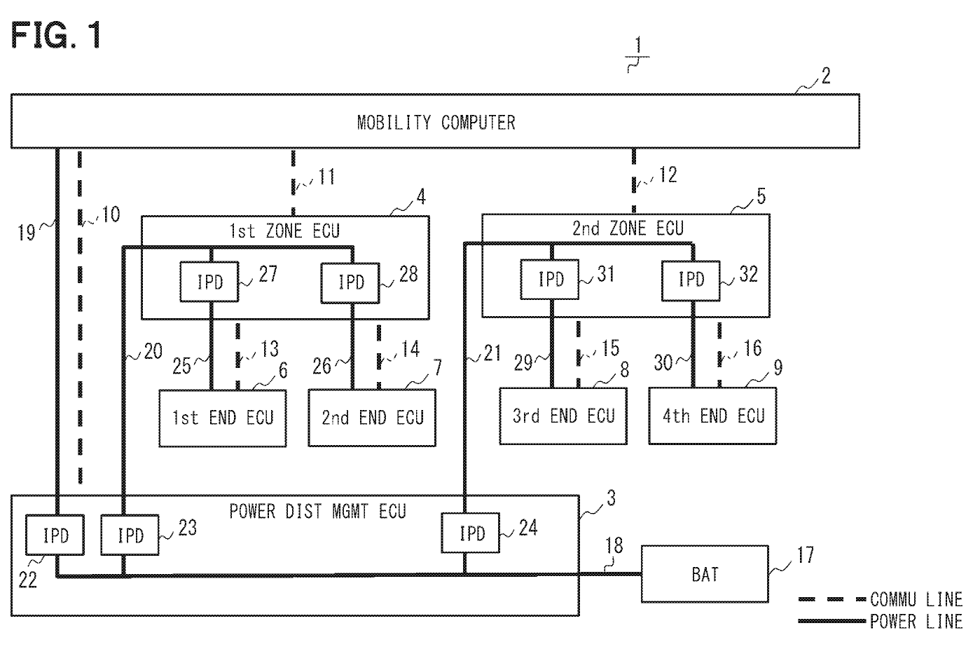

As shown in FIG. 1, the communication system 1 mounted on a vehicle (corresponding to a movable object) includes a mobility computer (hereinafter referred to as "mobility computer") 2 (corresponding to a management device), a power distribution management ECU 3 (corresponding to a power distribution management device) communicably connected to the mobility computer 2, a first zone ECU 4 (electronic control unit, corresponding to a first electronic control unit) and a second zone ECU 5 (electronic control unit, corresponding to a first electronic control unit), a first end ECU 6 (electronic control unit, corresponding to a second electronic control unit) and a second end ECU 7 (corresponding to a second electronic control unit) communicably connected to the first zone ECU 4, and a third end ECU 8 (electronic control unit, corresponding to a second electronic control unit) and a fourth end ECU 9 (corresponding to a second electronic control unit) communicably connected to the second zone ECU 5.

In FIG. 1, two first zone ECUs 4 and 5 are illustrated as examples of zone ECUs communicably connected to the mobility computer 2; however, the number of zone ECUs communicably connected to the mobility computer 2 may be one or three or more. In addition, two end ECUs 6 and 7 are illustrated as examples of end ECUs communicably connected to the first zone ECU 4; however, the number of end ECUs communicably connected to the first zone ECU 4 may be one or three or more. Similarly, two end ECUs 8 and 9 are illustrated as examples of end ECUs communicably connected to the second zone ECU 5; however, the number of end ECUs communicably connected to the second zone ECU 5 may be one or three or more.

The mobility computer 2 is a control device capable of controlling operations of the power distribution management ECU 3, the zone ECUs 4 and 5, and the end ECUs 6 to 9. The mobility computer 2 and the power distribution management ECU 3 are communicably connected via a communication line 10. The mobility computer 2 and the first zone ECU 4 are communicably connected via a communication line 11. The mobility computer 2 and the second zone ECU 5 are communicably connected via a communication line 12.

The first zone ECU 4 and the first end ECU 6 are communicably connected via a communication line 13. The first zone ECU 4 and the second end ECU 7 are communicably connected via a communication line 14. The second zone ECU 5 and the third end ECU 8 are communicably connected via a communication line 15. The second zone ECU 5 and the fourth end ECU 9 are communicably connected via a communication line 16. The communication lines 10 to 16 are communication lines enabling communications based on communication frames conforming to such communication protocols as, for example, the CAN (Controller Area Network) protocol or CAN FD (CAN with Flexible Data Rate) protocol, etc.

The power distribution management ECU 3 is supplied with power from the battery 17 via a power line 18, distributes the power, supplied from the battery 17, to the mobility computer 2 and the zone ECUs 4 and 5, distributes the power to the end ECUs 6 and 7 via the first zone ECU 4, and distributes the power to the end ECUs 8 and 9 via the second zone ECU 5.

The power distribution management ECU 3 and the mobility computer 2 are connected so as to enable power distribution via a power line 19. The power distribution management ECU 3 is equipped with an IPD (Intelligent Power Device), which is a high-performance semiconductor power switch interposed between the power line 18 and the power line 19.

The IPD is a high-performance semiconductor power switch that has a built-in protection circuit and is capable of absorbing energy from inductive loads or the like. the IPD may also be referred to as a semiconductor fuse, IPS (Intelligent Power Switch), smart switch, or high-side/low-side switch. Compared to mechanical relays that have mechanical contacts, the IPD does not have mechanical contacts, providing advantages such as superior mechanical durability and quiet operation, as well as a more compact size. In addition, since it is equipped with the protection functions that are not present in mechanical relays, high reliability can also be ensured.

The IPD 22 is basically always ON, and the power from the battery 17 is always supplied to the mobility computer 2. In the present embodiment, but it is also possible to adopt a configuration in which the IPD 22 can be turned OFF. For example, in cases of no-use for a long period of time due to transportation by ship or the like, it is possible to temporarily turn OFF the IPD 22, thereby suppressing dark currents to the mobility computer 2 and reducing the power consumption of the battery 17. It should be noted that, when the IPD 22 is temporarily turned OFF, the supply of the power from the battery 17 to the mobility computer 2 is stopped. In this case, such a configuration may be adopted that, during the period in which the power supply is stopped, the mobility computer 2 is operated in a low power consumption state by a built-in battery, so that the mobility computer 2 can switch the IPD 22 from OFF to ON. Alternatively, such a configuration may be adopted that the mobility computer 2 and the battery 17 are directly connected, so that power from the battery 17 is continuously supplied to the mobility computer 2. In that case, the power line 19 and the IPD 22 are absent.

The power distribution management ECU 3 and the first zone ECU 4 are connected so as to enable power distribution via a power line 20. The power distribution management ECU 3 and the second zone ECU 5 are connected so as to enable power distribution via a power line 21. The power distribution management ECU 3 includes an the IPD 23 interposed between the power line 18 and the power line 20, and an the IPD 24 interposed between the power line 18 and the power line 21.

The power distribution management ECU 3 turns the IPD 23 ON and OFF based on ON/OFF instructions for the IPD 23 from the mobility computer 2, thereby alternating between a power supplying state in which the power is supplied to the first zone ECU 4 and a power cutoff state in which the supply of the power to the first zone ECU 4 is cut off. For example, when the IPD 23 is turned ON, the supply of the power from the power distribution management ECU 3 to the first zone ECU 4 is started, and when the IPD 23 is turned OFF, the supply of the power from the power distribution management ECU 3 to the first zone ECU 4 is ended. The power distribution management ECU 3 turns the IPD 24 ON and OFF based on ON/OFF instructions for the IPD 24 from the mobility computer 2, thereby alternating between a power supplying state in which the power is supplied to the second zone ECU 5 and a power cutoff state in which the supply of the power to the second zone ECU 5 is cut off. For example, when the IPD 24 is turned ON, the supply of the power from the power distribution management ECU 3 to the second zone ECU 5 is started, and when the IPD 24 is turned OFF, the supply of the power from the power distribution management ECU 3 to the second zone ECU 5 is ended.

The first zone ECU 4 and the first end ECU 6 are connected so as to enable power distribution via the power line 25 The first zone ECU 4 and the second end ECU 7 are connected so as to enable power distribution via the power line 26. The first zone ECU 4 includes an the IPD 27 interposed between the power line 20 and the power line 25, and an the IPD 28 interposed between the power line 20 and the power line 26.

The first zone ECU 4 switches the IPD 27 ON and OFF based on ON/OFF instructions for the IPD 27 from the mobility computer 2, thereby alternating between a power supplying state in which the power is supplied to the first end ECU 6 and a power cutoff state in which the supply of the power to the first end ECU 6 is cut off. For example, when the IPD 27 is turned ON, the supply of power from the first zone ECU 4 to the first end ECU 6 is started, and when the IPD 27 is turned OFF, the supply of power from the first zone ECU 4 to the first end ECU 6 is ended. The first zone ECU 4 switches the IPD 28 ON and OFF based on ON/OFF instructions for the IPD 28 from the mobility computer 2, thereby alternating between a power supplying state in which the power is supplied to the second end ECU 7 and a power cutoff state in which the supply of the power to the second end ECU 7 is cut off. For example, when the IPD 28 is turned ON, the supply of power from the first zone ECU 4 to the second end ECU 7 is started, and when the IPD 28 is turned OFF, the supply of power from the first zone ECU 4 to the second end ECU 7 is ended.

The second zone ECU 5 and the third end ECU 8 are connected so as to enable power distribution via a power line 29, and the second zone ECU 5 and the fourth end ECU 9 are connected so as to enable power distribution via a power line 30. The second zone ECU 5 includes an the IPD 31 interposed between the power line 21 and the power line 29, and an the IPD 32 interposed between the power line 21 and the power line 30.

The second zone ECU 5 switches the IPD 31 ON and OFF based on ON/OFF instructions for the IPD 31 from the mobility computer 2, thereby alternating between a power supplying state in which the power is supplied to the third end ECU 8 and a power cutoff state in which the supply of the power to the third end ECU 8 is cut off. For example, when the IPD 31 is turned ON, the supply of power from the second zone ECU 5 to the third end ECU 8 is started, and when the IPD 31 is turned OFF, the supply of power from the second zone ECU 5 to the third end ECU 8 is ended. The second zone ECU 5 switches the IPD 32 ON and OFF based on ON/OFF instructions for the IPD 32 from the mobility computer 2, thereby alternating between a power supplying state in which the power is supplied to the fourth end ECU 9 and a power cutoff state in which the supply of the power to the fourth end ECU 9 is cut off. For example, when the IPD 32 is turned ON, the supply of power from the second zone ECU 5 to the fourth end ECU 9 is started, and when the IPD 32 is turned OFF, the supply of power from the second zone ECU 5 to the fourth end ECU 9 is ended.

The above configuration may be modified such that some of the ECUs, the zone ECUs 4 and 5 and the end ECUs 6 to 9, are directly connected to the battery 17 and are always supplied with the power from the battery 17.

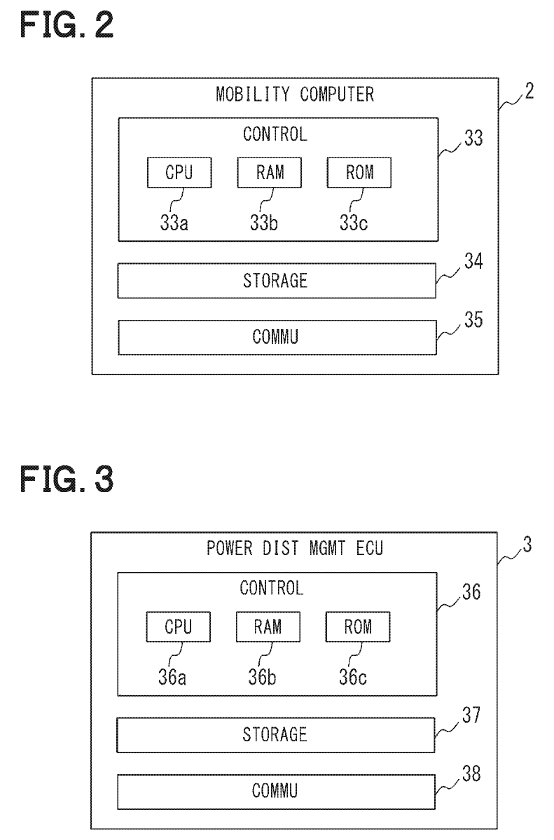

As shown in FIG. 2, the mobility computer 2 includes a mobility computer control unit 33 (corresponding to a control unit and a controller), a mobility computer storage unit 34, and a mobility computer communication unit 35. The mobility computer control unit 33 performs various computational processing related to operation of the mobility computer 2 and the like, and may include, as its main configuration, a microcomputer having a well-known CPU 33a, RAM 33b, ROM 33c, and the like for example. Various functions of the mobility computer control unit 33 are provided by the CPU 33a executing programs stored on a non-transitory tangible storage medium. The non-transitory tangible storage medium is, for example, the ROM 33c. When the program is executed by the CPU 33a, a method corresponding to the program is carried out. In the present embodiment, when a startup stop control program of the electronic control unit is executed by the CPU 33a, a startup stop control method corresponding to the startup stop control program is carried out. The number of microcomputers constituting the mobility computer control unit 33 may be one or two or more. Further, the various functions provided by the mobility computer control unit 33 are not limited to those by software; part or all may be implemented using one or more pieces of hardware. For example, in cases where the above-described function is implemented by electronic circuits as hardware, the electronic circuits may be digital circuits including a large number of logic circuits, analog circuits, or combinations of these.

The mobility computer storage unit 34 include, for example, such a non-volatile memory as a flash memory or EEPROM, which allows various types of data to be rewritable. The vehicle power state, which will be described later, is stored in the mobility computer storage unit 34. Specifically, information of the vehicle power state is stored in the mobility computer storage unit 34. The mobility computer communication unit 35 controls data communication with the power distribution management ECU 3 via the communication line 10, data communication with the first zone ECU 4 via the communication line 11, and data communication with the second zone ECU 5 via the communication line 12.

As shown in FIG. 3, the power distribution management ECU 3 includes a power distribution management control unit 36, a power distribution management storage unit 37, and a power distribution management communication unit 38.

The power distribution management control unit 36 is a device (also called a controller) that performs various computational processing related to the operation of the power distribution management ECU 3, and may include, as its main configuration, a microcomputer having, for example, a known CPU 36a, RAM 36b, ROM 36c, and the like for example. Various functions of the power distribution management control unit 36 are provided by the CPU 36a executing programs stored on a non-transitory tangible storage medium. The non-transitory tangible storage medium is, for example, the ROM 36c. When the program is executed by the CPU 36a, the method corresponding to the program is carried out. In the present embodiment, when the vehicle power state management program is executed by the CPU 36a, the management method corresponding to the vehicle power state management program is carried out. The number of microcomputers constituting the power distribution management control unit 36 may be one or may be plural. Further, the various functions provided by the power distribution management control unit 36 are not limited to those by software, and some or all of the elements may be implemented using one or more pieces of hardware. For example, if the above-described functions are implemented by electronic circuits as hardware, those electronic circuits may be realized by digital circuits including a large number of logic circuits, analog circuits, or a combination thereof.

The power distribution management storage unit 37 is, for example, a well-known non-volatile memory, such as a flash memory or EEPROM, in which diverse types of data can be rewritten. The vehicle power state is stored in the power distribution management storage unit 37. Specifically, the power distribution management ECU retains self-retaining information of the vehicle power state in the power distribution management storage unit 37. It is also possible to provide a volatile memory separately from the power distribution management storage unit 37, and the vehicle power state may be stored in the volatile memory. The power distribution management communication unit 38 controls data communication with the mobility computer 2 via the communication line 10.

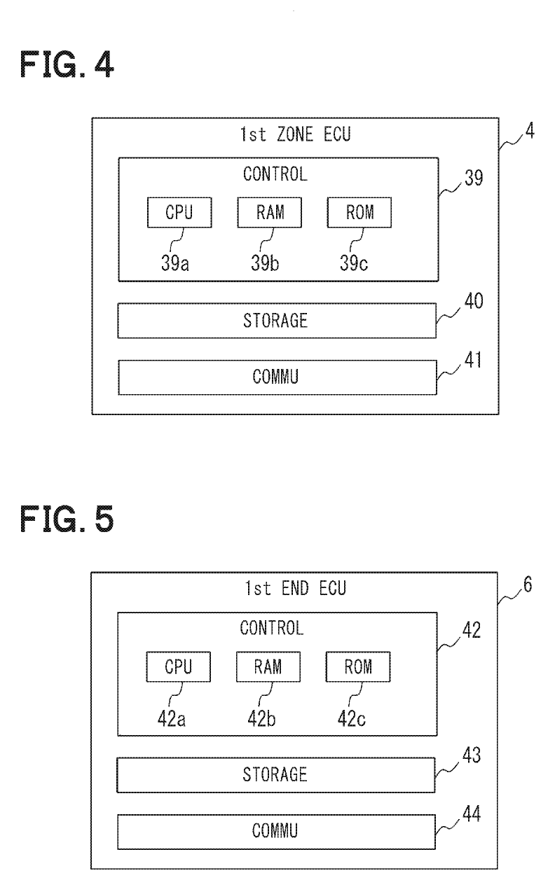

As shown in FIG. 4, the first zone ECU 4 includes a first zone control unit 39, a first zone storage unit 40, and a first zone communication unit 41. The second zone ECU 5 has the same configuration as the first zone ECU 4.

The first zone control unit 39 is a device (also called a controller) that performs various computational processing related to the operation of the first zone ECU 4, and may include, as its main configuration, a microcomputer that includes, for example, a known CPU 39a, RAM 39b, ROM 39c, and the like for example. Various functions of the first zone control unit 39 are provided by the CPU 39a executing programs stored on a non-transitory tangible storage medium. The non-transitory tangible storage medium is, for example, the ROM 39c. When the program is executed by the CPU 39a, a method corresponding to the program is carried out. In the present embodiment, when the vehicle power state management program is executed by the CPU 39a, a management method corresponding to the vehicle power state management program is carried out. The number of microcomputers constituting the first zone control unit 39 may be one or may be plural. Further, the various functions provided by the first zone control unit 39 are not limited to those by software; some or all may be implemented using one or more hardware components. For example, when the above-mentioned functions are implemented by hardware in the form of electronic circuits, such electronic circuits may be digital circuits including a large number of logic circuits, analog circuits, or combinations of these.

The first zone storage unit 40 include a non-volatile memory, such as a rewritable flash memory or EEPROM, which allows diverse types of data to be rewritable. The vehicle power state is stored in the first zone storage unit 40. Specifically, the first zone ECU retains self-retaining information of the vehicle power in the first zone storage unit 40. A volatile memory may be provided separately from the first zone storage unit 40, and the vehicle power state may be stored in the volatile memory. The first zone communication unit 41 controls data communication with the mobility computer 2 via the communication line 11, data communication with the first end ECU 6 via the communication line 13, and data communication with the second end ECU 7 via the communication line 14.

As shown in FIG. 5, the first end ECU 6 includes a first end control unit 42, a first end storage unit 43, and a first end communication unit 44. The second end ECU 7, the third end ECU 8, and the fourth end ECU 9 have the same configuration as the first end ECU 6.

The first end control unit 42 is a device (also called a controller) that performs various computational processing related to the operation of the first end ECU 6, and may include, as its main configuration, a microcomputer having, for example, a known CPU 42a, RAM 42b, ROM 42c, and the like for example. Various functions of the first end control unit 42 are provided by the CPU 42a executing programs stored on a non-transitory tangible storage medium. The non-transitory tangible storage medium is, for example, the ROM 42c. When the program is executed by the CPU 42a, the method corresponding to the program is carried out. In the present embodiment, when the vehicle power state management program is executed by the CPU 42a, the management method corresponding to the vehicle power state management program is carried out. The number of microcomputers constituting the first end control unit 42 may be one or may be plural. Further, the various functions provided by the first end control unit 42 are not limited to those by software; some or all may be implemented using one or more pieces of hardware. For example, in cases where the above-mentioned functions are implemented by an electronic circuit as hardware, the electronic circuit may be a digital circuit including a large number of logic circuits, an analog circuit, or a combination thereof.

The first end storage unit 43 includes, for example, a non-volatile memory, such as a rewritable flash memory or EEPROM, capable of storing various data in a rewritable manner. The vehicle power state is stored in the first end storage unit 43. Specifically, the first end ECU retains self-retaining information of the vehicle power in the first end storage unit 43. A volatile memory may be provided separately from the first end storage unit 43, and the vehicle power state may be stored in the volatile memory. The first end communication unit 44 controls data communication with the first zone ECU 4 via the communication line 13.

The communication system 1 performs control by combining: startup stop control via a relay based on the ON/OFF of the IPD; and startup stop control by switching to a wake-up state or a sleep state based on communication frames. The communication frames are also referred to herein as NM (Network Management) frames, NM messages. The startup stop control via a relay based on IPD ON/OFF is also referred to herein as "via-relay-startup-stop-control" and corresponds to first startup stop control. The startup stop control by switching to a wake-up state or a sleep state based on communication frames is also referred herein to as "communication-frame-based startup stop control.” The via-relay-startup-stop-control includes startup control via the relay based on IPD ON and stop control via the relay based on IPD OFF. The communication-frame-based startup stop control includes startup control by switching from the sleep state to the wake-up state based on a wake-up request communication frame, and stop control by switching from the wake-up state to the sleep state based on a sleep request communication frame.

The via-relay-startup-stop-control uses an the IPD-ON signal for instructing turn ON of the IPD and an the IPD-OFF signal for instructing turn OFF of the IPD. For example, the ECU having received the IPD-ON signal from the mobility computer 2 turns ON the IPD specified by the received IPD-ON signal, and starts supplying the power to the ECUs that the IPD is connected to as the power distribution target of the IPD. The ECU having received the IPD-OFF signal from the mobility computer 2 turns OFF the IPD specified by the received the IPD-off signal, and ends supplying power to the ECUs that the IPD is connected to as the power distribution target of the IPD.

The communication-frame-based startup stop control uses the value of a determined bit in the data field of the communication frame. For example, a communication frame in which the determined bit of the data field is set to "1" is used as a wake-up request communication frame, and a communication frame in which the determined bit of the data field is set to "0" is used as a sleep request communication frame. For example, the ECU, upon receiving a communication frame from the mobility computer 2, determines the value stored in the determined bit of the received communication frame. If the value is "1," the ECU transitions from the sleep state to the wake-up state or keeps the wake-up state. If the value is "0," the ECU transitions from the wake-up state to the sleep state or keeps the sleep state. The ECU may maintain the wake-up state during a period of time in which the wake-up request communication frames from the mobility computer 2 are successfully received at a determined interval, and the ECU may transition from the wake-up state to the sleep state if a period of time during which no wake-up request communication frame is received reaches a certain period of time. The wake-up state refers to a normal operating state in which the functions assigned to the ECU can be used without restrictions. The sleep state is a low power consumption operating state in which the available functions are limited. The communication frame is not limited to being transmitted from the mobility computer 2. The communication frame may also be transmitted from another ECU.

The via-relay-startup-stop-control by the mobility computer 2 includes: transmitting an the IPD ON signal to the ECU arranged in an upper level than the control target ECU to turns ON the IPD thereby executing the startup control for the control target ECU; and transmitting the IPD OFF signal to turn OFF the IPD, thereby executing stop control for the control target ECU. For example, when the control target ECU is the first zone ECU 4, the mobility computer 2 transmits the IPD ON signal to the power distribution management ECU 3, which is arranged in an upper level than the first zone ECU 4, to start up the first zone ECU 4 by turning ON the IPD 23. The mobility computer 2 transmits the IPD OFF signal to stop the first zone ECU 4 by turning OFF the IPD 23. Also, for example, when the control target ECU is the first end ECU 6, the mobility computer 2 transmits the IPD ON signal to the first zone ECU 4, which is arranged in an upper level than the first end ECU 6, to start up the first end ECU 6 by turning ON the IPD 27. The mobility computer 2 transmits the IPD OFF signal to stops the first end ECU 6 by turning OFF the IPD 27.

The communication-frame-based startup stop control by the mobility computer 2 includes: transitioning the control target ECU to a wake-up state by transmitting a wake-up request communication frame addressed to the control target ECU, and transitions the control target ECU to a sleep state by transmitting a sleep request communication frame. For example, when the control target ECU is the first zone ECU 4, the mobility computer 2 transitions the first zone ECU 4 to a wake-up state by transmitting a wake-up request communication frame addressed to the first zone ECU 4, and transitions the first zone ECU 4 to a sleep state by transmitting a sleep request communication frame. Also, for example, when the control target ECU is the first end ECU 6, the mobility computer 2 transitions the first end ECU 6 to a wake-up state by transmitting a wake-up request communication frame addressed to the first end ECU 6, and transitions the first end ECU 6 to a sleep state by transmitting a sleep request communication frame. It should be noted that when the supply of power to an ECU is started by turning ON the IPD arranged in an upper level, the ECU enters the wake-up state accordingly. In this case, it is unnecessary for the mobility computer 2 to transmit a wake-up request communication frame to the ECU to which the supply of power has been started.

In the above configuration, the following processing is executed as the operation of the system.

(1) Startup stop control based on scenes.

(2) Startup stop control by timeout method.

(3) Management of vehicle power state.

In the below, each processing will be described in order.

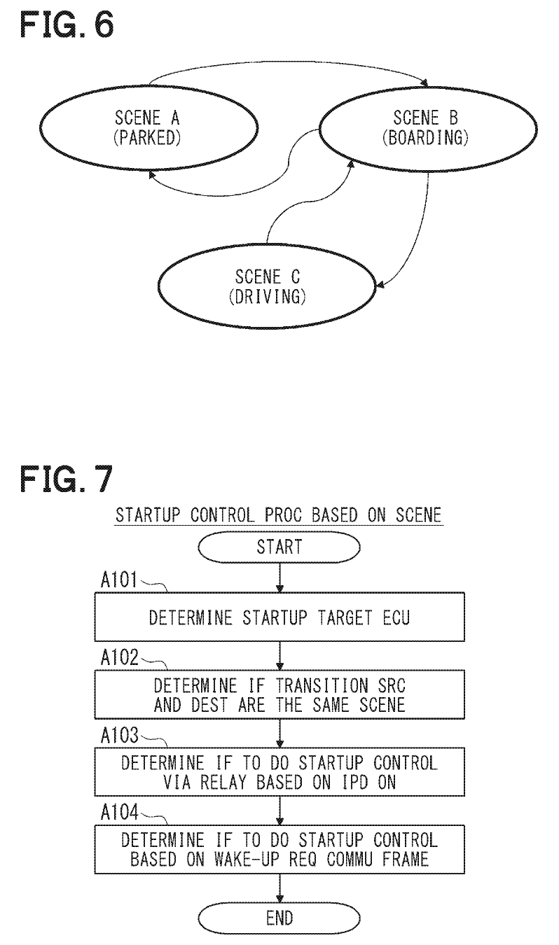

(1) Startup stop control based on scenes (see FIGS. 6 to 11).

In the startup stop control based on scenes, the mobility computer 2 manages scenes related to the behavior of the vehicle. When a startup request or stop request to a control target ECU is generated, the mobility computer 2 determines, based on the destination scene, whether to perform the via-relay-startup-stop-control and whether to perform the communication-frame-based startup stop control. It should be noted that turning the IPD ON may be referred to as "relay ON,” and turning the IPD OFF may be referred to as "relay OFF." In addition, the mobility computer 2 manages a function within the scene and, when a startup stop request for a control target ECU is generated, determines whether to perform the via-relay-startup-stop-control based on the type of function, and determines whether to perform the communication-frame-based startup stop control. Here, "scene" includes concepts of vehicle state and function. The vehicle state includes not only concepts such as parked, boarding, and driving, but also concepts related to the vehicle power state, such as +B state, ACC state, and IG state. The term “function” includes not only concept of function executed by so-called an application, but also the concept of subsystem comprising one or more ECUs.

As shown in FIG. 6, the scene A, the scene B, and the scene C are assumed as scenes for the vehicle as a whole, and it is assumed that state transition occurs between the scene A and the scene B, and between the scene B and the scene C. The scene A is, for example, a parked state. The scene B is, for example, a boarding state. The scene C is, for example, a driving state. The following describes startup control and stop control. The scene is determined by the mobility computer 2 and stored in the mobility computer storage unit 34.

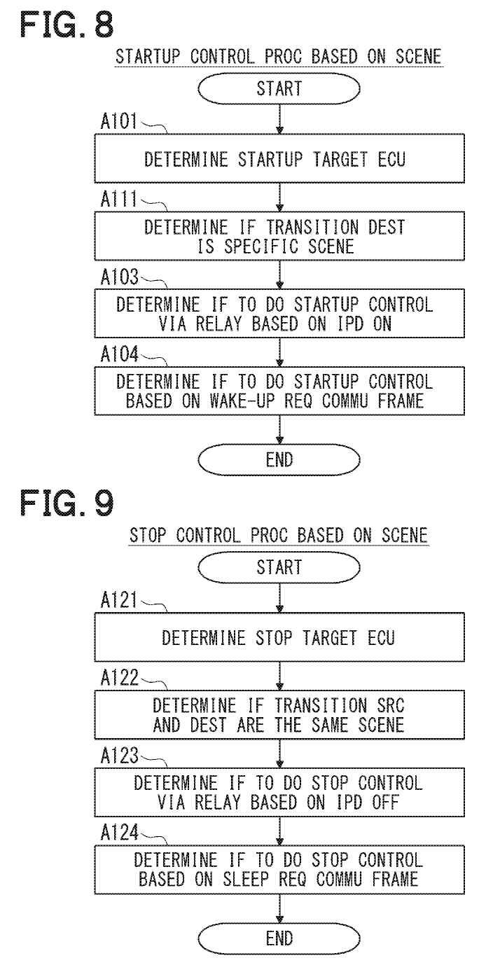

### 1-1 Startup control processing based on the scene see FIGs. 7 and 8

As shown in FIG. 7, upon the mobility computer 2 accepting a startup request from, for example, an application, the mobility computer 2 specifies the accepted startup request and determines a startup target ECU (A101). In this case, the following patterns exist as patterns of accepting a startup request. The first pattern is a case where the mobility computer 2 acquires a request to start up the startup target ECU from a module of the mobility computer 2 or from another ECU. In this case, upon the mobility computer 2 acquiring a startup request for the startup target ECU from a module of the mobility computer 2 or from another ECU, the mobility computer 2 determines the startup target ECU based on the acquired startup request.

The second pattern is a case where the mobility computer 2 acquires a request to start a determined function from a module of the mobility computer 2 or from another ECU. In this case, upon the mobility computer 2 acquiring a request to start a determined function from a module of the mobility computer 2 or from another ECU, the mobility computer 2 determines the startup target function based on the acquired start request. Then, the mobility computer 2 determines the ECU associated with the determined start-up target function as the startup target ECU.

The third pattern is a case where the mobility computer 2 acquires an execution request for a start event from a module of the mobility computer 2 or from another ECU. In this case, upon the mobility computer 2 acquiring an execution request for a start event from an module of the mobility computer 2 or from another ECU, the mobility computer 2 determines the startup target function that is associated with the acquired start event execution request, and then determines the ECU associated with the determined startup target function as the start target ECU.

Since there is a possibility that startup request for the startup target ECU, the request to start determined functions, and the execution request for a start events may be generated simultaneously from, for example, multiple applications, the mobility computer 2 determines the startup target ECU according to logical AND or logical OR. For example, the mobility computer 2 determines that an ECU for which at least one startup request has been accepted is the startup target ECU, and determines that an ECU for which all of the accepted requests are stop requests is a stop target ECU.

Upon the mobility computer 2 determining the startup target ECU, the mobility computer 2 determines whether a source scene and a destination scene are the same (A102). Based on the result of determining whether the source scene and the destination scene are the same, the mobility computer 2 decides whether to perform startup control via a relay based on IPD ON (A103), and decides whether to perform startup control based on the wake-up request communication frame (A104).

Specifically, for example, if the accepted startup request is a startup request causing the parking scene to be kept and the source scene and the destination scene are the same, the mobility computer 2 decides not to perform startup control via a relay based on IPD ON, but decides to perform only startup control based on the wake-up request communication frame. For example, if the accepted startup request is a startup request causing state transition from the parking scene to the boarding scene, and the source scene and the destination scene are different, the mobility computer 2 decides to perform both startup control via a relay based on IPD ON and startup control based on the wake-up request communication frame.

The foregoing has described the case where it is determined whether the source scene and the destination scene are the same. However, as shown in FIG. 8, instead of determining whether the source scene and the destination scene are the same, the mobility computer 2 may determine whether the destination scene is a particular scene (A111), and based on the result of that determination, decide whether to perform startup control via a relay based on IPD ON (A103), and decide whether to perform startup control based on the wake-up request communication frame (A104).

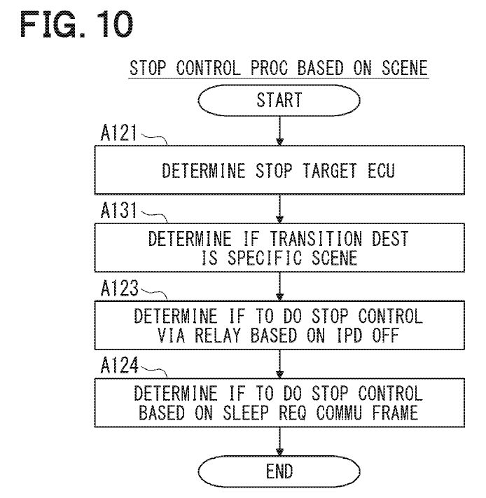

### 1-2 Stop Control Processing Based on Scenes see FIGs. 9 and 10

As shown in FIG. 9, upon the mobility computer 2 accepting a stop request from, for example, an application, the mobility computer 2 specifies the received stop request and determines the stop target ECU(A121). In this case, there are the following patterns of accepting a stop request. The first pattern is the case where the mobility computer 2 acquires a request to stop the stop target ECU from a module of the mobility computer 2 or from another ECU. In this case, upon the mobility computer 2 acquiring the stop request for the stop target ECU from a module of the mobility computer 2 or from another ECU, the mobility computer 2 determines the stop target ECU based on the acquired stop request.

The second pattern is the case where the mobility computer 2 acquires a request to end a determined function from a module of the mobility computer 2 or from another ECU. In this case, upon the mobility computer 2 acquiring the end request for a determined function from an module of the mobility computer 2 or from another ECU, the mobility computer 2 determines the stop target function based on the acquired end request, and then determines that the ECU associated with the determined stop target function is the stop target ECU.

The third pattern is the case where the mobility computer 2 acquires an execution request for an end event from a module of the mobility computer 2 or from another ECU. In this case, upon the mobility computer 2 acquiring an execution request for an end event from an module of the mobility computer 2 or from another ECU, the mobility computer 2 determines a stop target function that is associated with the end event based on the acquired execution request, and determines that the ECU associated with the determined stop target function is the stop target ECU.

Since the stop request for the stop target ECUs, the end request for the determined function, and the execution request for the end event may occur simultaneously from, for example, multiple applications in the mobility computer 2, the stop target ECU is determined according to logical AND and/or logical OR. For example, the mobility computer 2 determines that an ECU for which at least one stop request has been accepted is a stop target ECU, and determines that an ECU for which all of the accepted requests are startup requests is a startup target ECU.

Upon the mobility computer 2 determining the stop target ECU, the mobility computer 2 determines whether the source scene and the destination scene are the same (A122). Based on the determination result as to whether the source scene and the destination scene are the same, the mobility computer 2 decides whether to perform the stop control via a relay based on IPD OFF (A123), and decides whether to perform the stop control based on a sleep request communication frame (A124).

For example, if the stop request accepted by the mobility computer 2 is a stop request causing the parking scene to be kept and the source scene and destination scene are the same, the mobility computer 2 determines not to perform the stop control via a relay based on IPD OFF, but to perform only the stop control based on the sleep request communication frame. For example, if the stop request accepted by the mobility computer 2 is a startup request causing state transition from the parking scene to the boarding scene, and the source scene and destination scene are different, the mobility computer 2 determines to perform both the stop control via a relay based on IPD OFF and the stop control based on the sleep request communication frame.

The above has described the case of determining whether the source scene and the destination scene are the same. Alternatively, as shown in FIG. 10, instead of determining whether the source scene and the destination scene are the same, the mobility computer 2 may determine whether the destination scene is a particular scene (A131), and based on the result of this determination, decide whether to perform the stop control via a relay based on IPD OFF (A123), and decide whether to perform the stop control based on the sleep request communication frame (A124).

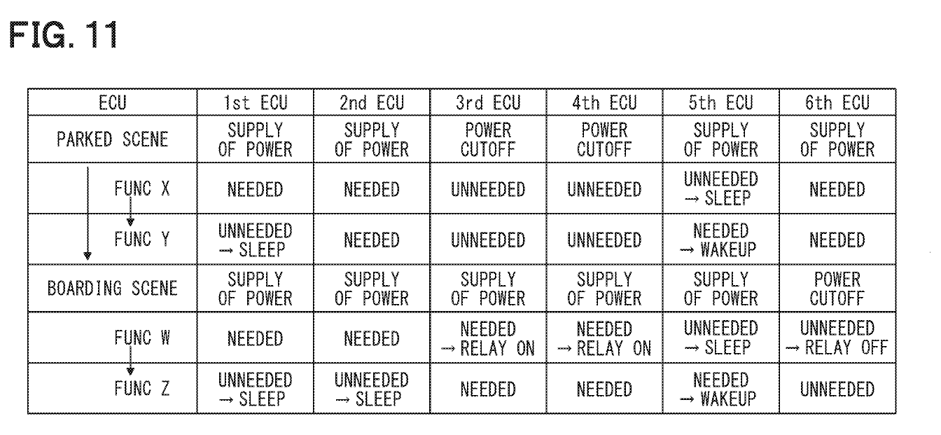

As shown in FIG. 11, the mobility computer 2 manages a management table for each scene, such as the parking scene and the boarding scene. The management table may be stored in an area separate from the control program, or it may be incorporated within the control program. The first ECU to the sixth ECU correspond, for example, to any of the power distribution management ECU 3, zone ECUs 4 and 5, or end ECUs 6 to 9 described in FIG. 1. For each scene, “powered ECU” and "power cutoff ECU” are defined in advance. The “powered ECU” is an ECUs to be supplied with power by default and the "power cutoff ECU” is an ECU to which the supply of the power is to be cut off by default. In the example shown in FIG. 11, in the parking scene, the first ECU, the second ECU, the fifth ECU, and the sixth ECU are defined as the powered ECUs, while the third ECU and the fourth ECU are defined as the power-cutoff ECUs. In the boarding scene, the first ECU, the second ECU, the third ECU, the fourth ECU, and the fifth ECU are defined as the powered ECUs, while the sixth ECU is defined as the power-cutoff ECU.

During the state transition from the parking scene to the boarding scene, the mobility computer 2 performs the startup control on the third ECU and the fourth ECU by turning the relay ON, because "power cutoff" is defined for the third ECU and the fourth ECU in the parking scene and "powered" is defined for the third ECU and the fourth ECU in the boarding scene. Further, during the state transition from the parking scene to the boarding scene, the mobility computer 2 performs the stop control on the sixth ECU by turning the relay OFF because "powered" is defined for the sixth ECU in the parking scene and "power cutoff" is defined for the sixth ECU in the boarding scene.

In the parking scene, upon the mobility computer 2 specifying, as in the first pattern described above, that, for example, an occurrence of the startup request for the first ECU, the second ECU, and the sixth ECU associated with a function X, the mobility computer 2 specifies that startup of the first ECU, the second ECU, and the sixth ECU is necessary. Further, upon when the mobility computer 2 specifying, as in the second pattern described above, that, for example, an occurrence of the startup request for a function X, the mobility computer 2 determines that the first ECU, the second ECU, and the sixth ECU associated with the function X are the ECUs for startup request, and specifies that startup of the first ECU, the second ECU, and the sixth ECU is necessary. Furthermore, upon the mobility computer 2 specifying, as in the third pattern described above, that an execution request for a start event has occurred and that the start event is associated with a function X, the mobility computer 2 determines the function X as the startup target function, determines that the first ECU, the second ECU, and the sixth ECU associated with the function X are the ECUs for startup request, and specifies that startup of the first ECU, the second ECU, and the sixth ECU is necessary.

The mobility computer 2 keeps the supply of power to the first ECU, the second ECU, and the sixth ECU specified as the startup necessary ECUs. The mobility computer 2 performs the stop control for the fifth ECU specified as the startup unnecessary ECUs, by switching the fifth ECU from the wake-up state to the sleep state.

Similarly, in the parking scene, upon the mobility computer 2 specifying, as in the first pattern described above, an occurrence of the startup request for the second ECU, the fifth ECU, and the sixth ECU associated with the function Y, the mobility computer 2 specifies that startup of the second ECU, the fifth ECU, and the sixth ECU is necessary. Further, upon the mobility computer 2 specifying, as in the second pattern described above, for example, an occurrence of the startup request for the function Y, the mobility computer 2 determines the second ECU, the fifth ECU, and the sixth ECU associated with the function Y are the ECUs for startup request and specifies that startup of the second ECU, the fifth ECU, and the sixth ECU is necessary. Furthermore, upon the mobility computer 2 specifying, as in the third pattern described above, that an execution request for a start event has occurred and that the start event is associated with the function Y, the mobility computer 2 determines the function Y as the startup target function, determines that the second ECU, the fifth ECU, and the sixth ECU associated with the function Y are the ECUs for startup request, and specifies that startup of the second ECU, the fifth ECU, and the sixth ECU is necessary.

The mobility computer 2 keeps the supply of power to the second ECU and the sixth ECU specified as the startup necessary ECUs. The mobility computer 2 performs the startup control for the fifth ECU specified as the startup necessary ECU, by switching the fifth ECU from the sleep state to the wake-up state. The mobility computer 2 performs the stop control for the first ECU specified as the startup unnecessary ECU, by switching it from the wake-up state to the sleep state.

FIG. 11 shows an example in which the function X is ended and the function Y is started; however, there are also cases where the function Y is started while the function X lasts without being ended. In such a case, the mobility computer 2 does not perform the stop control for the first ECU by switching the first ECU from the wake-up state to the sleep state, but rather maintains the first ECU in the wake-up state.

In the boarding scene, upon the mobility computer 2 specifying, as in the first pattern described above, an occurrence of the startup request for the first ECU, the second ECU, the third ECU, and the fourth ECU each associated with function W, the mobility computer 2 specifies that startup of the first ECU, second ECU, third ECU, and fourth ECU is necessary. Further, upon the mobility computer 2 specifying that as in the second pattern described above, an occurrence of the startup request for a function W, the mobility computer 2 determines that the first ECU, the second ECU, the third ECU, and the fourth ECU each associated with the function W are the ECUs for startup requests, and specifies that startup of the first ECU, the second ECU, the third ECU, and the fourth ECU is necessary. Furthermore, upon the mobility computer 2 specifying that as in the third pattern described above, an execution request for a start event has occurs and the start event is associated with function W, the mobility computer 2 designates the function W as the startup target function, determines that the first ECU, the second ECU, the third ECU, and the fourth ECU each associated with the function W are the ECUs for starts requests, and specifies that startup of the first ECU, the second ECU, the third ECU, and the fourth ECU is necessary.

The mobility computer 2 keeps supplying the power to the first ECU and second ECU specified as the startup necessary ECUs. The mobility computer 2 performs the relay-on startup control for the third ECU and the fourth ECU specified as the startup necessary ECUs. The mobility computer 2 performs the stop control for the fifth ECU specified as the startup unnecessary ECUs, by switching it from the wake-up state to the sleep state. The mobility computer 2 performs the stop control for the sixth ECU specified as the startup unnecessary ECU, by turning the relay OFF.

Similarly, in the boarding scene, upon the mobility computer 2 specifying, as in the aforementioned first pattern, an occurrence of the startup request for, for example, the third ECU, the fourth ECU, and the fifth ECU associated with a function Z, the mobility computer 2 specifies that startup is necessary for the third ECU, the fourth ECU, and the fifth ECU. Further, upon the mobility computer 2 specifying, as in the aforementioned second pattern, for example, an occurrence of the startup request for the function Z, the mobility computer 2 determines that the third ECU, the fourth ECU, and the fifth ECU associated with the function Z are the ECUs for startup request and specifies that startup is necessary for the third ECU, the fourth ECU, and the fifth ECU. Furthermore, upon the mobility computer 2 specifying that as in the aforementioned third pattern, an execution request for a start event has occurred and the start event is associated with a function Z, the mobility computer 2 determines the function Z as the startup target function, determines that the third ECU, the fourth ECU, and the fifth ECU associated with the function Z are the ECUs for start requests and specifies that startup is necessary for the third ECU, the fourth ECU, and the fifth ECU.

The mobility computer 2 keeps supplying power to the third ECU and the fifth ECU specified as the startup necessary ECUs. The mobility computer 2 performs the startup control for the fifth ECU specified as the startup necessary ECU, by switching the fifth ECU from the sleep state to the wake-up state. The mobility computer 2 performs the stop control for the first ECU and the second ECU specified as the startup unnecessary ECU, by switching the first ECU and the second ECU from the wake-up state to the sleep state.

FIG. 11 shows an example in which the function W is ended and the function Z is started; however, there are cases where the function Z is started while the function W lasts without being ended. In such a case, the mobility computer 2 does not perform the stop control by switching the first ECU and the second ECU from the wake-up state to the sleep state, but instead maintains the wake-up state of the first ECU and the second ECU.

Scenes in some cases are defined as separate scenes to determine whether to perform the via-relay-startup-stop-control and whether to perform the communication-frame-based startup stop control. The some cases include for example cases where the startup target ECU is dynamically changed while the parked scene is being kept, such as cases where vehicle diagnostics, vehicle information collection, software update or the like is performed in the parked state by OTA (Over the Air).

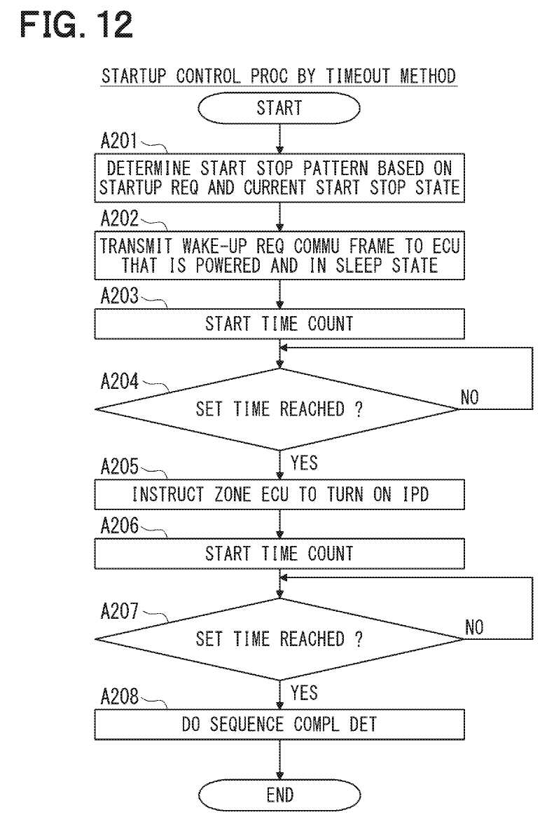

### 2 Startup stop control by timeout method see Figures 12 to 15

As shown in FIG. 1, the first zone ECU 4 and the second zone ECU 5 are arranged to be supplied with the power from the power distribution management ECU 3. The end ECUs 6 and 7 are arranged to be supplied with the power from the first zone ECU 4. The end ECUs 8 and 9 are arranged to be supplied with the power from the second zone ECU 5. Further, the power distribution management ECU 3, the first zone ECU 4, and the second zone ECU 5 are arranged to be communicable from the mobility computer 2. The end ECUs 6 and 7 are arranged to be communicable from the first zone ECU 4. The end ECUs 8 and 9 are arranged to be communicable from the second zone ECU 5. In such a hierarchical architecture (having a plurality level in hierarchy), it is necessary to perform the supply of power and the switching from the sleep state to the wake-up state, in order from the upper level to the upper level. In this case, a control sequence for the control target ECU in the upper level is performed and thereafter, the control sequence for the control target ECU in the lower level is performed. Further, it is necessary to perform the power cutoff and the switching from the wake-up state to the sleep state, in order from the lower level to the upper level. In this case, the control sequence for the control target ECU in the lower level is performed and thereafter the control sequence for the control target ECU in the upper level is performed.

In the startup stop control by timeout method, after initiating the startup stop control sequence for a certain hierarchical level, time count s started, and upon the time count reaching a set time, the startup stop control sequence at the next hierarchical level is initiated. In the startup control, when the control sequence for from the uppermost target ECU to the lowermost target ECU is defined as the overall control sequence, the control sequence for the uppermost target ECU is initiated first and the time count is started. Once the time count reaches a set time, the control sequence for the next hierarchical level is initiated. Specifically, each time the time count reaches a set time for the upper-level control sequence, the lower-level control sequence is initiated, and the overall control sequence is completed upon the time count reaching the set time for the control sequence for the lowest-level target ECU.

In the stop control, when the control sequence for from the lowest-level target ECU to the highest-level target ECU is defined as the overall control sequence, the control sequence for the lowest-level target ECU is initiated first and the time count is started. Once the time count reaches a set time, the control sequence for the next hierarchical level is initiated. Specifically, each time a set time for a lower-level control sequence is reached, an upper-level control sequence is initiated, in other words, the control sequence for the next hierarchical level is initiated. Upon the set time for the uppermost control target ecu is reached, the overall control sequence is completed.

In case the execution of a control sequence for a certain level is not normally completed, the control sequence for the next hierarchical level is initiated. In this case, while the hierarchical level having an occurrence of startup stop failure maintains as it is, the execution of the control sequence may be completed.

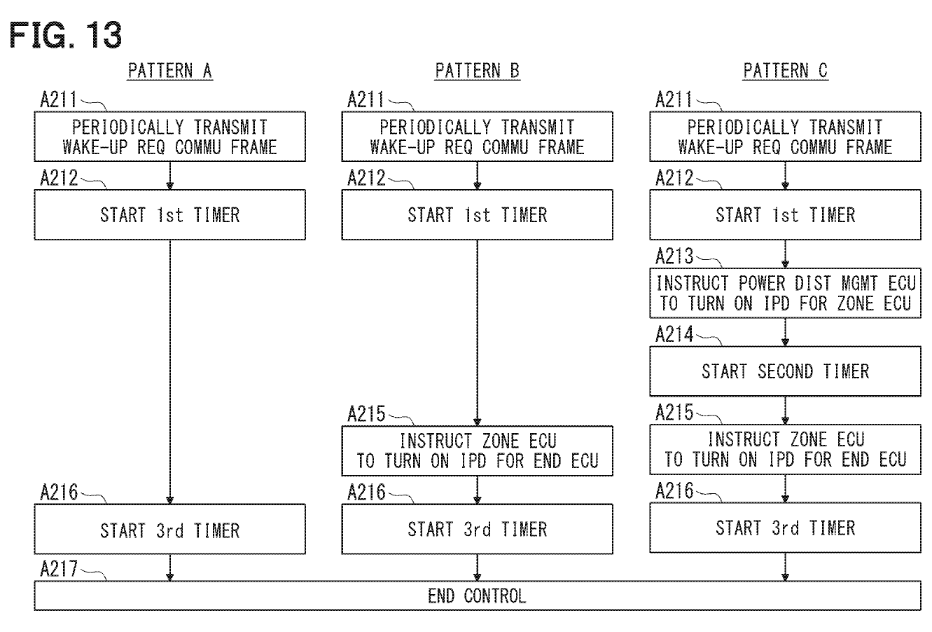

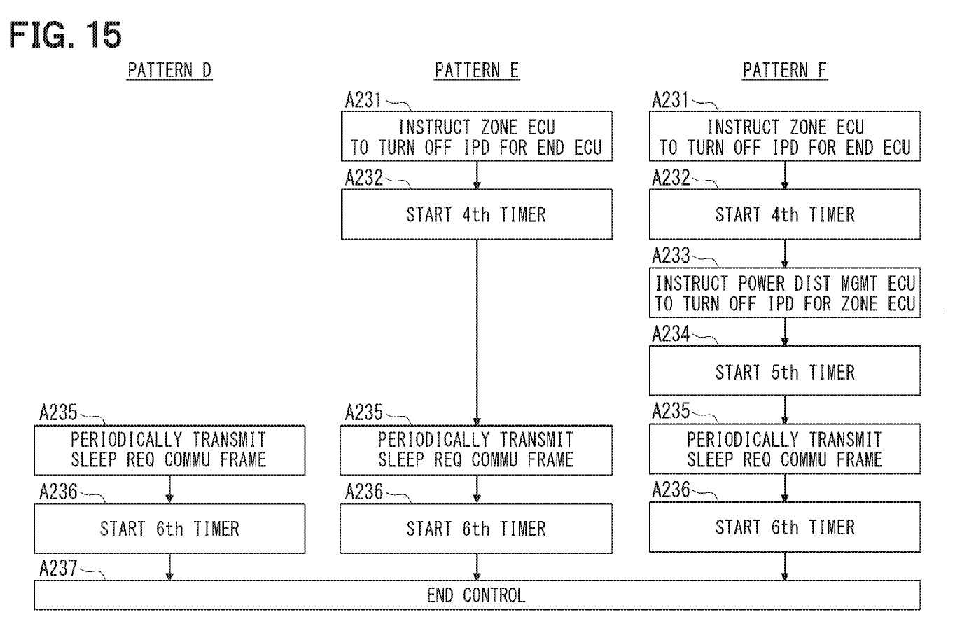

In cases of executing multiple control sequences simultaneously, the set time for a respective control sequence is set to a parameter in common among the overall system or set to a parameter on a zone-by-zone basis. The common parameter may be set to follow the control sequence having the longest execution time among the multiple control sequences. In cases where it is necessary to startup the first end ECU 6 and the second end ECU arranged in a lower level than the first zone ECU 4, as well as the third end ECU 8 arranged in a lower than the second zone ECU 5 in FIG. 1 for example, ,the set time for the overall control sequence of the zone including the first zone ECU 4 and the set time for the overall control sequence of the zone including the second zone ECU 5 are both adjusted to follow the control sequence having the longest execution time. The set time of the timer will be described later with reference to FIGS. 13 and 15.

If a rapid increase in power consumption due to turning ON multiple the IPDs simultaneously is anticipated, the startup timing of the end ECUs in each zone is adjusted. In case an ECU startup/stop fails, only some of the ECUs are stated up or stopped. In this case, measures against the startup/stop failing ECU are taken using a fail-safe function of each zone based on safety concept of the domain. In cases of executing multiple control sequences in parallel, the time count is separately performed for each control sequence or a single time count is used to implement waiting for the elapse of the time count for the preceding control sequence.

### 2-1 Startup control processing by timeout method see FIG. 12 to FIG. 13

The startup control processing will be described on the assumption that in FIG. 1 the power distribution management ECU 3, the first zone ECU 4, and the end ECUs 6 and 7 are in such states that: the power distribution management ECU 3 is always supplied with the power and in a sleep state; the first zone ECU 4 is being supplied with the power and in a sleep state; the first end ECU 6 is being supplied with the power and in a sleep state; and the second end ECU 7 is not being supplied with the power. The state of being supplied with the power includes: a case of being always supplied with the power due to being directly connected to the battery 17 or due to always ON of the IPD of the upper level ECU; and a case of being supplied with the power on an as-needed basis due to switching on the IPD of the upper-level ECU when required.

As shown in FIG. 12, upon the mobility computer 2 accepting a startup request from, for example, an application, the mobility computer 2 determines a startup stop pattern based on the received accepted request and the current startup stop state (A201). Specifically, the mobility computer 2 determines the startup stop pattern in accordance with FIG. 11 described above. The mobility computer 2 transmits a wake-up request communication frame to an ECUs that is being supplied with the power and is in a sleep state (A202), and starts the time count (A203). In this case, the mobility computer 2 transmits a wake-up request communication frame to the ECUs that are being supplied with the power and in a sleep state, which are the power distribution management ECU 3 and the first zone ECU 4, and starts time count.

The mobility computer 2 waits for the count to reach a set time. The set time may be preset. Upon specifying that the count has reached the set time (A204: YES), the mobility computer instructs the zone ECU to turn ON the IPD that corresponds to the end ECU not being supplied with the power (A205), and starts the time count (A206). Even if normal completion in response to the wake-up request is not successfully confirmed in A204, the mobility computer 2 proceeds to A205. If the normal completion is confirmed before counting the set time, the processing may proceed to A205 without waiting for the count to reach the set time.

In this case, since the ECU not being supplied with the power is the second end ECU 7, the mobility computer 2 instructs the first zone ECU 4 to turn ON the IPD 28 corresponding to the second end ECU 7, and starts time count. The first zone ECU 4 turns ON the IPD 28 based on the instruction which is from the mobility computer and which instructs for turn ON of the IPD 28, and starts supplying the power to the second end ECU 7.

Upon the mobility computer 2 starting time count, the mobility computer 2 waits for elapse of the set time. The set time may be preset. Upon the mobility computer 2 specifying that the set time has been counted (A207: YES), the mobility computer 2 performs a sequence completion determination of whether the control sequence is successfully completed (A208). In A207, even if normal completion in response to the IPD ON instruction is not successfully confirmed, the mobility computer 2 proceeds to A208. If normal completion is confirmed before counting the set time, the processing may proceed to A208 without waiting for elapse of the set time.

Through the above-described processing, the mobility computer 2 executes the startup control sequences in order from the upper level, specifically in order from the power distribution management ECU 3, the first zone ECU 4, and the end ECUs 6 and 7. Specifically, the mobility computer 2 starts the control sequence for the power distribution management ECU 3, and after ending the control sequence for the power distribution management ECU 3, starts the control sequence for the first zone ECU 4. After ending the control sequence for the first zone ECU 4, the mobility computer 2 starts the control sequence for the end ECUs 6 and 7.

As shown in FIG. 13, the mobility computer 2 is configured to control the control sequence of three patterns with respect to the startup. The pattern A is a pattern in which the start is caused by the wake-up request communication frame alone. The Pattern B is a pattern in which turning ON the IPD for the end ECU is involved. The Pattern C is a pattern in which turning ON the IPDs for both the zone ECU and the end ECU is involved. For these patterns, the mobility computer 2 performs timer management in the below-described ways.

### 2-1-1 Pattern A

The startup control processing will be described on the assumption that in FIG. 1, the power distribution management ECU 3, the first zone ECU 4, and the end ECUs 6 and 7 are in such states: the power distribution management ECU 3 is always supplied with the power and in a sleep state; the first zone ECU 4 is supplied with the power and in a sleep state; and the end ECUs 6 and 7 are supplied with power and in a sleep state.

The mobility computer 2 periodically transmits wake-up request communication frames to the first zone ECU 4, the power distribution management ECU 3, and the end ECUs 6 and 7 (A211). The mobility computer 2 sets a first timer and starts the time count using the first timer (A212). The first timer is a timer that measures an elapsed time when transitioning the zone ECU 4 or the power distribution management ECU 3 from the sleep state to the wake-up state. Upon the mobility computer 2 specifying that the set time has been counted, the mobility computer 2 sets a third timer and starts the time count using the third timer (A216). The third timer is a timer that measures the elapsed time when transitioning the end ECUs 6 and 7 from the sleep state to the wake-up state. In cases where the end ECUs 6 and 7 are not being supplied with power, the third timer is a timer that measures the elapsed time when starting up the end ECUs 6 and 7. Upon the mobility computer 2 specifying that the set time has been counted, the mobility computer 2 ends the control (A217).

In the above, the mobility computer 2 periodically transmits communication frames in which the bits corresponding to the first zone ECU 4, the power distribution management ECU 3, and the end ECUs 6 and 7 are set to 1 (wake-up). The first zone ECU 4 and the power distribution management ECU 3, which have received the wake-up request communication frame from the mobility computer 2, transition from the sleep state to the wake-up state. Subsequently, the first zone ECU 4, having transitioned from the sleep state to the wake-up state, forwards the wake-up request communication frame to the end ECUs 6 and 7. Subsequently, the end ECUs 6 and 7, to which the wake-up request communication frame has been forwarded from the first zone ECU 4, transition from the sleep state to the wake-up state. The mobility computer 2 may be configured such that in a stage of setting the first timer, the mobility computer 2 periodically transmits communication frames in which the bits corresponding to the first zone ECU 4 and the power distribution management ECU 3 are set to “1”, and that in a stage of setting the third timer, the mobility computer 2 periodically transmits communication frames in which the bits corresponding to the first zone ECU 4, the power distribution management ECU 3, and the end ECUs 6 and 7 are set to “1”.

### 2-1-2 Pattern B

The startup control processing will be described on the assumption that in FIG. 1, the power distribution management ECU 3, the first zone ECU 4, and the end ECUs 6 and 7 are in such states that: the power distribution management ECU 3 is always supplied with the power due to the always ON of the IPD23 and is in a sleep state; the first zone ECU 4 is always supplied with the power and in a sleep state; and the end ECUs 6 and 7 are not being supplied with the power.

The mobility computer 2 periodically transmits wake-up request communication frames to the first zone ECU 4, the power distribution management ECU 3, and the end ECUs 6 and 7 (A211). The mobility computer 2 sets a first timer and starts the time count with the first timer (A212). Upon the mobility computer 2 specifying that the set time has elapsed, the mobility computer 2 instructs the first zone ECU 4 to turn ON the IPD27 and the IPD26 corresponding to the end ECUs 6 and 7 not being supplied with power (A215). The mobility computer 2 sets a third timer and starts the time count with the third timer (A216). Upon the mobility computer 2 specifying that the set time has elapsed, the mobility computer 2 ends the control (A217).

In the above, the mobility computer 2 periodically transmits communication frames in which the bits corresponding to the first zone ECU 4 and the power distribution management ECU 3 are set to 1 where 1 indicates wake-up. The first zone ECU 4 and the power distribution management ECU 3, having received the wake-up request communication frame from the mobility computer 2, transition from the sleep state to the wake-up state. Subsequently, the first zone ECU 4, having received the ON instruction for the IPD27 and the IPD26 from the mobility computer 2, turns ON the IPD27 and the IPD26. Subsequently, the end ECUs 6 and 7 start up to which the supply of the power has been started by the turning ON of the IPD27 and the IPD26 in the first zone ECU 4.

It should be noted that the above-described pattern B corresponds to the flowchart in FIG. 12. A203 indicates the first timer corresponding to A212, and A206 indicates the third timer corresponding to A216.

### 2-1-3 Pattern C

The startup control processing will be described assuming that n FIG. 1, the power distribution management ECU 3, the first zone ECU 4, and the end ECUs 6 and 7 are in such states that: the power distribution management ECU 3 is always supplied with the power and in a sleep state; the first zone ECU 4 is not being supplied with the power; and the end ECUs 6 and 7 are not being supplied with the power.

The mobility computer 2 periodically transmits wake-up request communication frames to the first zone ECU 4, the power distribution management ECU 3, and the end ECUs 6 and 7 (A211). The mobility computer 2 sets a first timer to measure the startup of the power distribution management ECU 3 and starts the time count using the first timer (A212). Upon the mobility computer 2 specifying that the set time has elapsed, the mobility computer 2 instructs the power distribution management ECU 3 to turn ON the IPD 23 corresponding to the first zone ECU 4 not being supplied with the power (A213). The mobility computer 2 sets a second timer and starts the time count using the second timer (A214). The second timer is a timer that measures the elapsed time when starting up the first zone ECU 4. Upon the mobility computer 2 specifying that the set time has elapsed, the mobility computer 2 instructs the first zone ECU 4 to turn ON the IPD 27 and 26 corresponding to the end ECUs 6 and 7 not being supplied with the power (A215). The mobility computer 2 sets a third timer and starts the time count using the third timer (A216). Upon the mobility computer 2 specifying that the set time has elapsed, the mobility computer ends the control (A217).

In the above, the mobility computer 2 periodically transmits communication frames in which "1" (wake-up) is set in the bit corresponding to the power distribution management ECU 3. The power distribution management ECU 3, having received the wake-up request communication frame from the mobility computer 2, transitions from the sleep state to the wake-up state. Subsequently, the power distribution management ECU 3, having received an ON instruction for the IPD23 from the mobility computer 2, turns ON the IPD23. Subsequently, the first zone ECU 4 starts up to which the supply of power has started up due to the turning ON of the IPD23 of the power distribution management ECU 3. Subsequently, the first zone ECU 4, having received the ON instructions for the IPD27 and the IPD26 from the mobility computer 2, turns ON the IPD27 and the IPD26. Subsequently, the end ECUs 6 and 7 start up to which the supply of power has started up due to the turning ON of the IPD27 and the IPD26 of the first zone ECU 4.

In some cases, the mobility computer 2 may execute control sequences of the aforementioned patterns A, B, and C simultaneously. Such cases include, for example, a case where the startup sequence for the first zone ECU 4 and end ECUs 6 and 7 is of the pattern A, the startup sequence for the second zone ECU 5 and end ECUs 8 and 9 is of the pattern B, and the startup sequence for a third zone ECU (not shown) and its subordinate end ECUs is of the pattern C.

The timer setting in the startup control will be described. Regarding the three patterns described with FIG. 13 , the first zone ECU 4 and the end ECUs 6 and 7, which are the targets of the control sequence of the pattern A, are referred to as an area A; the second zone ECU 5 and the end ECUs 8 and 9, which are the targets of the control sequence of the pattern B, are referred to as an area B; and the third zone ECU and its subordinate fifth end ECU and sixth end ECU, which are the targets of the control sequence of the pattern C, are referred to as an area C, for example.

In the example shown in FIG. 13, a first timer, a second timer, and a third timer are provided. The first timer is used in the control sequences for the areas A, B, and C; the second timer is used only in the control sequence for the area C; and the third timer is used in the control sequences for the areas A, B, and C. The set time for the third timer, which is a final timer, may be set common among all the areas, or may be set individually for each area.

In cases where the set time for the third timer is commonly set for all the areas, the set time for the third timer is determined based on the longest startup time of the end ECU among the overall system, the set time for the third timer is set to the longest startup time plus margin. The startup time is a time from initiation of the startup processing to end of the startup processing. In this case, when the third timer reaches the set time, the control is ended. In another case where the set time for the third timer is set individually for each area, the set time for the third timer for the zone A, the set time for the third timer for the zone B, and the set time for the third timer for the zone C may differ from one another. In this case, the control sequences for the areas A, B, and C may be executed simultaneously, so that the control is not ended even if the third timer for any one of the areas reaches its set time and that all of the third timers reaching their set times are waited for and the control is ended upon all of the third timers reaching their set times.

The following describes the case in which the control sequences for areas A, B, and C. namely, the control sequences of the patterns A, B, and C in FIG. 13, are executed simultaneously. In FIG. 13, the mobility computer 2 periodically transmits wake-up request communication frames to the power distribution management ECU 3, the area A, the area B, and the area C (A211). Specifically, the mobility computer 2 periodically transmits the wake-up request communication frames to the power distribution management ECU 3, the first zone ECU 4, the second zone ECU 5, and the third zone ECU. The mobility computer 2 starts the time count with the first timer (A212). Upon the mobility computer 2 specifying the first timer reaching the set time, the mobility computer 2 instructs the power distribution management ECU to turn ON the IPD corresponding to the third zone ECU not being supplied with the power in the area C (A213). The mobility computer 2 starts the time count with the second timer (A214). In this case, even if the mobility computer 2 specifies the first timer reaching the set time, the mobility computer 2 does not start A215 for the area B (pattern B), and waits to start A215.

Upon the mobility computer 2 specifying the second timer reaching the set time, the mobility computer 2 instructs the second zone ECU and the third zone ECU to turn ON the IPDs corresponding to the end ECUs (the third end ECU 8, the fourth end ECU 9, the fifth end ECU, and the sixth end ECU) not being supplied with the power in the area B and the area C (A215). Specifically, the mobility computer 2 starts A215 upon the second timer reaching the set time, so that the mobility computer 2 starts A215 for the area B and A215 for the area C at the same timing. The mobility computer 2 starts the time count with the third timer (A216). Upon the mobility computer 2 specifying the third timer reaching the set time, the mobility computer 2 ends the control for all of the areas A, B, and C (A217).

For example, in a case where the set time of the first timer for the area B is "t1 and " the set time of the first timer for the area C is "t2" and the set time of the second timer for the area C is "t3," "t1" may be set so as to satisfy the condition "t1 = t2 + t3." In this case, since the timing when the first timer for the area B (pattern B) reaches its set time coincides with the timing when the second timer for the area C (pattern C) reaches its set time, A215 for the area B and A215 for the area C are started at the same timing.

The following describes a case of simultaneously executing the control sequences for the areas A and B, specifically, the control sequences of the patterns A and B in FIG. 13. In FIG. 13, the mobility computer 2 periodically transmits the wake-up request communication frames to the power distribution management ECU, the area A, and the area B (A211). Specifically, the mobility computer 2 periodically transmits the wake-up request communication frames to the power distribution management ECU 3, the first zone ECU 4, and the second zone ECU 5. The mobility computer 2 starts the time count with the first timer (A212). Upon the mobility computer 2 specifying the first timer reaching the set time, the mobility computer 2 instructs the second zone ECU to turn ON the IPDs corresponding to the end ECUs (third end ECU 8 and fourth end ECU 9) not being supplied with power in the area B (A215). Specifically, the mobility computer 2 regards the set time of the unused second timer as "zero" and starts A215. The mobility computer 2 starts the time count with the third timer (A216). Upon the mobility computer 2 specifying the third timer reaching the set time, the mobility computer 2 ends the control for the areas A and B (A217).

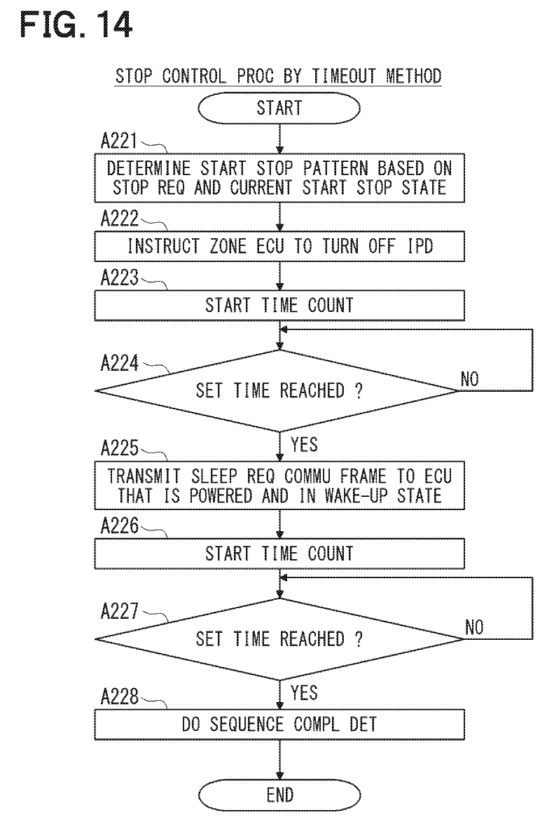

### 2-2 Stop control processing by timeout method see Figures 14 to 15

The stop control processing will be described on the assumption that in FIG. 1, the power distribution management ECU 3, the first zone ECU 4, and the end ECUs 6 and 7 are in such states that: the power distribution management ECU 3 is always supplied with the power and in a wake-up state; the first zone ECU 4 is supplied with the power and in a wake-up state; the first end ECU 6 is supplied with the power and in a wake-up state; and the second end ECU 7 is supplied with the power and in a wake-up state.

As shown in FIG. 14, upon the mobility computer 2 accepting the stop request from an application, the mobility computer 2 determines the startup-stop pattern based on the received stop request and the current startup-stop state (A221). Specifically, the mobility computer 2 determines the startup-stop pattern according to FIG. 11 described above. The mobility computer 2 instructs the zone ECU to turn OFF the IPD corresponding to the end ECU being supplied with the power (A222), and starts the time count (A223).

In this case, since the end ECUs being supplied with the power are the first end ECU 6 and the second end ECU 7, the mobility computer 2 instructs the first zone ECU 4 to turn OFF the IPD 27 corresponding to the first end ECU 6 and the IPD 28 corresponding to the second end ECU 7, and starts the time count. The first zone ECU 4 turns OFF the IPDs 27 and 28 based on the OFF instruction for the IPD 27 from the mobility computer 2, thereby ending the supply of power to the first end ECU 6 and the second end ECU 7.

The mobility computer 2 waits for the set time to be counted. Upon the mobility computer 2 specifying the count reaching the set time (A224: YES), the mobility computer 2 transmits sleep request communication frames to the ECU that is being supplied with the power and is in the wake-up state (A225). The mobility computer 2 proceeds to A225 even if normal completion in response to the IPD off instruction is not successfully confirmed in A224. The processing may be such that when normal completion is confirmed before the count reaches the set time, the processing proceeds to A225 without waiting for the count to reach the set time.

The mobility computer 2 starts the time count (A226). In this case, the mobility computer 2 transmits the sleep request communication frame to the first zone ECU 4 and the power distribution management ECU 3 which are being supplied with power and are in the wake-up state, and starts the time count. The processing may be such that the mobility computer 2 stops the periodic transmission of the wake-up request communication frame, thereby transitioning the ECU in the wake-up state to the sleep state.

The mobility computer 2 waits for the count to reach a set time. The set time may be preset. Upon the mobility computer 2 specifying the count reaching the set time (A227: YES), the mobility computer 2 performs a sequence completion determination of whether the control sequence is completed normally (A228). Even if normal completion in response to the sleep request is not successfully confirmed in A227, the mobility computer 2 proceeds to A228. The processing may be such that if the normal completion is confirmed before the count reaches the set time, the processing proceeds to A228 without waiting for the count to reach the set time.

With the above-mentioned processing, the mobility computer 2 executes the stop control sequences in an order from the lower level, specifically, the end ECUs 6 and 7, the first zone ECU 4 and the power distribution management ECU 3 in this order. For example, the mobility computer 2 starts the control sequence for the end ECUs 6 and 7, and after ending the control sequence for the end ECUs 6 and 7, starts the control sequence for the first zone ECU 4, and after ending the control sequence for the first zone ECU 4, starts the control sequence for the power distribution management ECU 3.

As shown in FIG. 15, the control sequences of three patterns with respect to the stop are controllable by the mobility computer 2. The pattern D is a pattern in which the sleep request communication frame alone causes the stop. The pattern E is a pattern involving turn OFF of the IPD of the end ECU. The pattern F is a pattern involving turn OFF of the IPDs of both the end ECU and the zone ECU. For these patterns, the mobility computer 2 manages the timers in the below-described ways.

### 2-2-1 Pattern D

The stop control processing will be described assuming that in FIG. 1, the power distribution management ECU 3, the first zone ECU 4, and the end ECUs 6 and 7 are in such states that: the power distribution management ECU 3 is always supplied with the power and in the wake-up state; the first zone ECU 4 is supplied with the power and in the wake-up state; and the end ECUs 6 and 7 are supplied with the power and in the wake-up state.

The mobility computer 2 periodically transmits the sleep request communication frames to the first zone ECU 4, the power distribution management ECU 3, and the end ECUs 6 and 7 (A235). The mobility computer 2 sets a sixth timer and starts the time count using the sixth timer (A236). The sixth timer is a timer that measures the elapsed time when transitioning the first zone ECU 4, the power distribution management ECU 3, and the end ECUs 6 and 7 from the wake-up state to the sleep state. Upon specifying the count reaching the set time, the mobility computer 2 ends the control (A237).

In this case, the first zone ECU 4, having received the sleep request communication frame from the mobility computer 2, forwards the sleep request communication frame to the end ECUs 6 and 7. The end ECUs 6 and 7, to which the sleep request communication frame has been forwarded from the first zone ECU 4, transition from the wake-up state to the sleep state. Subsequently, the first zone ECU 4 and the power distribution management ECU 3, which have received the sleep request communication frame from the mobility computer 2, transition from the wake-up state to the sleep state.

### 2-2-2 Pattern E

The stop control processing will be described assuming that in FIG. 1, the power distribution management ECU 3, the first zone ECU 4, and the end ECUs 6 and 7 are in such states that: the power distribution management ECU 3 is always supplied with the power and in the wake-up state; the first zone ECU 4 is always supplied with the power and in the wake-up state; and the end ECUs 6 and 7 are supplied with the power and in the wake-up state.

The mobility computer 2 instructs the first zone ECU 4 to turn OFF the IPDs 27 and 26 corresponding to end ECUs 6 and 7 being supplied with the power (A231). The mobility computer 2 sets a fourth timer and starts the time count with the fourth timer (A232). The fourth timer is a timer that measures the elapsed time when stopping the end ECUs 6 and 7. Upon specifying the count reaching the set time, the mobility computer 2 performs periodic transmission of sleep request communication frames to the first zone ECU 4 and the power distribution management ECU 3 (A235). The mobility computer 2 sets the sixth timer and starts the time count with the sixth timer (A236). Upon specifying the count reaching the set time, the mobility computer 2 ends the control (A237).

In this case, the first zone ECU 4, having received the OFF instruction for the IPDs 27 and 28 from the mobility computer 2, turns OFF the IPDs 27 and 28. Subsequently, the end ECUs 6 and 7 stops to which the supply of power has ended due to the turning OFF of the IPDs 27 and 28 of the first zone ECU 4. Subsequently, the first zone ECU 4 and the power distribution management ECU 3, having received the sleep request communication frame from the mobility computer 2, transition from the wake-up state to the sleep state.

### 2-2-3 Pattern F

The stop control processing will be described on assumption that in FIG. 1, the power distribution management ECU 3, the first zone ECU 4, and the end ECUs 6 and 7 are in such states that: the power distribution management ECU 3 is always supplied with the power and in the wake-up state; the first zone ECU 4 is supplied with power on an as-needed basis and in the wake-up state; and the end ECUs 6 and 7 are supplied with the power and in the wake-up state.

The mobility computer 2 instructs the first zone ECU 4 to turn OFF the IPDs 27 and 26 corresponding to the end ECUs 6 and 7 being supplied with the power (A231). The mobility computer 2 sets the fourth timer and starts the time count by the fourth timer (A232). Upon specifying the elapse of the set time, the mobility computer 2 instructs the power distribution management ECU 3 to turn OFF the IPD 23 corresponding to the first zone ECU 4 being supplied with the power (A233). The mobility computer 2 sets the fifth timer and starts the time count by the fifth timer (A234). The fifth timer is a timer that measures the elapsed time when stopping the first zone ECU 4. Upon specifying the elapse of the set time, the mobility computer 2 performs the periodic transmission of sleep request communication frames to the power distribution management ECU 3 (A235). The mobility computer 2 sets the sixth timer and starts the time count by the sixth timer (A236). Upon specifying the elapse of the set time, the mobility computer 2 ends the control (A237).

In this case, the first zone ECU 4, which has received the instruction for OFF of the IPD27 and 28 from the mobility computer 2, turns OFF the IPD27 and 28. Subsequently, the end ECUs 6 and 7 stop, the supply of power to which has been ended due to the turning OFF of the IPD27 and 28 of the first zone ECU 4. Subsequently, the power distribution management ECU 3, which has received the off instruction for the IPD23 from the mobility computer 2, turns OFF the IPD23. Subsequently, the first zone ECU 4 stops to which the supply of power has been ended due to the turning Off of the IPD23 of the power distribution management ECU 3. Subsequently, the power distribution management ECU 3, which has received the sleep request communication frame from the mobility computer 2, transitions from the wake-up state to the sleep state.

Regarding the above-mentioned patterns D, E, and F, the mobility computer 2 may simultaneously execute the control sequences related to these stops. For example, the stop sequence for the first zone ECU 4 and the end ECUs 6 and 7 corresponds to pattern D; the stop sequence for the second zone ECU 5 and the end ECUs 8 and 9 corresponds to pattern E; and the stop sequence for a third zone ECU (not shown) and its subordinate end ECUs corresponds to the pattern F.

The timer settings in the stop control will be described. Regarding the three patterns described in FIG. 15: the first zone ECU 4 and the end ECUs 6 and 7, which are the targets of the control sequence of the pattern D, are referred to as an area D; the second zone ECU 5 and the end ECUs 8 and 9, which are the targets of the control sequence of the pattern E, are referred to as an rea E; and the third zone ECU and its subordinate fifth and sixth end ECUs, which are the targets of the control sequence of the pattern F, are referred to as an area F, for example.

In the example illustrated in FIG. 15, a fourth timer, a fifth timer, and a sixth timer are provided. The fourth timer is used for both the area E and the area F; the fifth timer is used only for the area F; and the sixth timer is used for the area D, the area E, and the area F. The set time for the sixth timer, which is the final timer, may be set to a parameter common in all the areas or may be set separately for each area. Specifically, there are a case where a sixth timer is set commonly for all patterns of the stop sequence, and a case where the sixth timer is set separately for each pattern.

In the case where the set time of the sixth timer is set commonly for all the areas, the set time of the sixth timer is set to match the stop time of the ECU that has a longest stop time among the overall system, where the stop time is a time from the start of the stop processing to the end of the stop processing. Specifically, the set time is set to the longest stop time and a margin. In this case, upon the sixth timer reaching the set time, the control is ended. In another case where the set time of the sixth timer is set separately for each area, the set time of the sixth timer for the area D, that for the area E, and that for the area F may be different. In that case, even if the sixth timer for any of the areas reaches to its set time, the control does not end but waits. Upon the sixth timers for the all the areas reaching their respective set times, the control is ended for all the areas.

The following will describe the case of simultaneously executing the control sequences related to the stop of the areas D, E, and F, specifically, the control sequences of the patterns D, E, and F in FIG. 15. In FIG. 15, the mobility computer 2 instructs the zone ECU to turn OFF the IPDs corresponding to the end ECUs being supplied in the area E and the area F (A231). The IPD is turned OFF by the first zone ECU 4, and the supply of the power to the first end ECU 6 and the second end ECU 7 is cut off. The IPD is turned OFF by the second zone ECU 5, and the supply of the power to the third end ECU 8 and the fourth end ECU 9 is cut off. The IPD is turned OFF by the third zone ECU, and the supply of the power to the fifth end ECU and the sixth end ECU is cut off. The mobility computer 2 starts the time count using the fourth timer (A232). Upon specifying the fourth timer reaching the set time, the mobility computer 2 instructs the power distribution management ECU to turn OFF the IPD corresponding to the zone ECU being powered in the area F (A233). The IPD is turned OFF by the power distribution management ECU 3, and the supply of the power to the third zone ECU is cut off. The mobility computer 2 starts the time count with the fifth timer (A234). In this case, even if the mobility computer 2 specifies that the fourth timer reaches the set time, the mobility computer 2 does not start A235 in the area E and waits to start A235.

Upon specifying the fifth timer reaching the set time, the mobility computer 2 performs periodic transmission of the sleep request communication frames to the area D, the area E, and the area F (A235). Specifically, the mobility computer 2 starts A235 upon the fifth timer reaching the set time, and thereby, the mobility computer 2 starts A235 for the area E and the A235 for area F at the same timing. The first zone ECU 4, the second zone ECU 5, and the power distribution management ECU 3, which have received the communication frame, transition to the sleep state. The mobility computer 2 starts the time count with the sixth timer (A236). Upon specifying the sixth timer reaching the set time, the mobility computer 2 ends the control for all of the areas D, E, and F (A237).

For example, in a case where: the set time of the fourth timer for the area E is "t4”; that for the area F is "t5"; and that for the area F is "t6," "t4" may be set so satisfy "t4 = t5 + t6." In this case, the timing at which the fourth timer for the area E reaches the set time and the timing at which the fifth timer for the area F reaches the set time are the same timing, so that A235 for the area E and A235 for the area F are started at the same timing.

Among the zone ECUs and end ECUs to which the distribution of the power is stopped, there are some ECUs that need to perform end processing such as a learning process or the like before the supply of the power is stopped. Examples of such ECUs include a chassis system ECU and a powertrain system ECU. Therefore, a handshake process before the stop is performed on the ECUs of the chassis system and the powertrain system. The handshake process may refer to a procedure in which the power distribution is stopped between an ECU that issues the instruction for power distribution stop and an ECU that receives the instruction for power distribution stop (also referred to as a power distribution stop target ECU) ) after the end processing of the power distribution stop target ECU is completed. For example, in a case where the handshake process is performed between a zone ECU and an end ECU, the zone ECU transmits a power cutoff notification to the end ECU before turn OFF of the IPD, thereby causing the end ECU to start the end processing such as the learning process. The end ECU, upon receiving the power cutoff notification from the zone ECU, transmits an acknowledgment response to the zone ECU, the acknowledgment response including designation of the determined time required for the end processing such as learning processes. The zone ECU, upon receiving the acknowledgment response from the end ECU, sets a timer for measuring a time longer than the determined time designated in the acknowledgment response. Upon specifying the elapse of the set time, the zone ECU turns OFF the IPD that controls the supply of the power to the end ECU.

In this case, the system may be designed to have a timeout for the end processing and a forced stop function for the end processing, and the timer may be set such that the number of timers corresponds to the number of ECUs requiring the handshake process, where the ECUs requiring the handshake process may include a zone ECU and an end ECU. Additionally, a forced timer may be provided so that the timeout occurs if there is no power control request nor response. In addition, the ECUs are stopped in turn from the zone ECU or the end ECU completing preparations for the stop. Therefore, a timeout function is provided for each power control completion of a respective zone, and for each zone ECU and each end ECU corresponding to the handshake process.

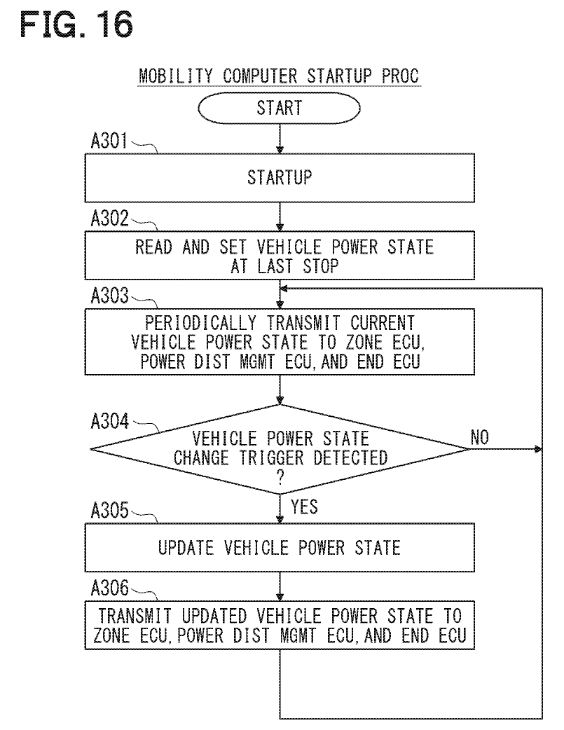

### 3 Management of vehicle power states see FIGs. 16 to 20

In the management of the vehicle power states indicating the power state of the vehicle as a whole, the power distribution management ECU 3, the first zone ECU 4, and the end ECUs 6 and 7 set their self-retaining information of the vehicle power state to “undefined” at their startup, and keeps the “undefined” in the self-retaining information until acquiring the latest vehicle power state information from the mobility computer 2. In the present embodiment, the vehicle power state is considered synonymous with the "scene" described in FIGS. 6 and 11 in the above. For example, the parking scene is s considered synonymous with the vehicle power state “parking,” the boarding scene is s considered synonymous with the vehicle power state “boarding,” and the driving scene is considered synonymous with the vehicle power state “driving.” Upon determining the vehicle power state information, the mobility computer 2 transmits the determined vehicle power state information to the first zone ECU 4. When the first zone ECU 4 receives the vehicle power state information from the mobility computer 2, the first zone ECU 4 transmits the received vehicle power state information to the end ECUs 6 and 7.

The power distribution management ECU 3, the first zone ECU 4, and the end ECUs 6 and 7 retaining the undefined as the vehicle power state operate only their minimum necessary function such as communication reception and the like, mask diagnosis concerning communication lost to ignore an abnormality obtained by the diagnosis. Specifically, even if the power distribution management ECU 3, the first zone ECU 4, or the end ECUs 6 and 7 determine the communication lost due to absence of receiving communication frames from communication counterpart ECUs, the power distribution management ECU 3, the first zone ECU 4, or the end ECUs 6 and 7 do not regard it as an abnormality. Alternatively, the power distribution management ECU 3, the first zone ECU 4, or the end ECUs 6 and 7 may be configured to, even if determining the occurrence of the communication lost, prohibit communication lost diagnostic code from being stored.

The power distribution management ECU 3, the first zone ECU 4, and the end ECUs 6 and 7 acquire the latest power state information from the mobility computer 2. In response to the acquired power state information indicating an under-state-transition (state transition is in progress), the power distribution management ECU 3, the first zone ECU 4, and the end ECUs 6 and 7 set their retaining information of “power state of vehicle as a whole” to "under-state-transition", so that the update to the under-state-transition is made. When retaining the information of the vehicle power state as the under-state-transition, the power distribution management ECU 3, the first zone ECU 4, and the end ECUs 6 and 7 mask the diagnosis concerning the communication lost to ignore abnormalities obtained by the diagnosis. The same applies to the second zone ECU 5 and the end ECUs 8 and 9.

### 3-1 Startup processing of mobility computer 2 see FIG. 16

As shown in FIG. 16, upon the mobility computer 2 starting up (A301), the mobility computer 2 reads out the vehicle power state saved in a memory by a save operation at the last stop, and sets the read vehicle power state (A302). The mobility computer 2 periodically transmits the current vehicle power state to the zone ECUs, the power distribution management ECU, and the end ECUs (A303). The zone ECU relays the vehicle power state transmitted from the mobility computer 2, so that the vehicle power state is periodically transmitted to the end ECUs. The mobility computer 2 determines whether a vehicle power state change trigger indicating a change in the vehicle power state due to, for example, the operation of an application, is detected (A304). Upon specifying that no vehicle power state change trigger has been detected (A304: NO), the process returns to A303 and repeats the periodic transmission of the current vehicle power state.

Upon the mobility computer 2 specifying that the vehicle power state change trigger has been detected (A304: YES), the mobility computer 2 updates the vehicle power state (A305), performs event-transmission (evet-driven transmission) of the updated vehicle power state as the latest vehicle power state to the zone ECUs, the power distribution management ECU, and the end ECUs (A306), and then returns to A303 to repeat the processing from A303.

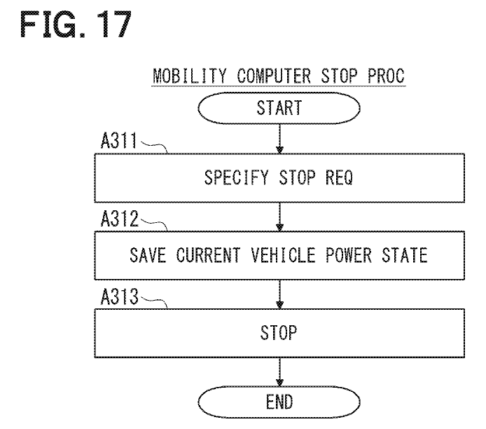

### 3-2 Stop processing of mobility computer 2 see FIG. 17

As shown in FIG. 17, Upon the mobility computer 2 specifying a stop request (A311), the mobility computer 2 performs a save operation of saving the current vehicle power state in the memory (A312) and then stops (A313).

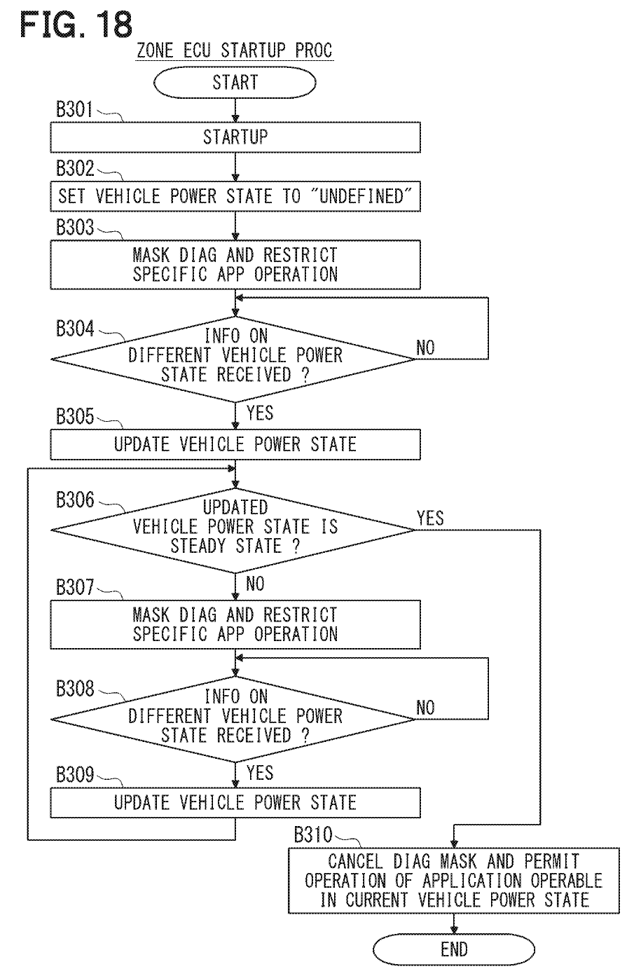

### 3-3 Startup processing of the first zone ECU 4 FIG. 18

Description will be given using the first zone ECU 4 as a representative example among the first zone ECU 4, the power distribution management ECU 3, and the end ECUs 6 and 7. As shown in FIG. 18, upon the first zone ECU 4 starting up in response to receiving an NM message (B301), the first zone ECU 4 sets the vehicle power state to "undefined" (B302, corresponding to the first step), masks the diagnosis, and restricts the operation of a particular application (B303). The first zone ECU 4 determines whether the vehicle power state information indicating a vehicle power state different from the current vehicle power state has been received (B304). Upon the first zone ECU 4 specifying that there is no receipt of the vehicle power state information indicating a vehicle power state different from the current vehicle power state (B304: NO), the first zone ECU 4 keeps masking the diagnosis and restricting the operation of a particular application.

Upon the first zone ECU 4 specifying that there is receipt of the vehicle power state information indicating a vehicle power state different from the current vehicle power state (B304: YES), the first zone ECU 4 updates the vehicle power state (B305) and determines whether the updated vehicle power state is a steady state (B306). Upon the first zone ECU 4 specifying that the updated vehicle power state is not a steady state, specifically, the updated vehicle power state is the under-state- transition (B306: NO), the first zone ECU 4 sets the vehicle power state in the self-retaining information to the "under-state-transition," masks the diagnosis, and restricts the operation of a particular application (B307).

The first zone ECU 4 determines whether the vehicle power state information indicating a vehicle power state different from the current vehicle power state has been received (B308). Upon the first zone ECU 4 specifying that there is no receiving of the vehicle power state information indicating a vehicle power state different from the current vehicle power state (B308: NO), the first zone ECU 4 keeps masking the diagnosis and restricting the operation of a particular application.

Upon the first zone ECU 4 specifying that the first zone ECU 4 has received the vehicle power state information indicating a vehicle power state different from the current vehicle power state (B308: YES), the first zone ECU 4 updates the vehicle power state based on the received vehicle power state information (B309, corresponding to the second procedure), returns to step B306, and repeats the processing from step B306 onward.

Upon the first zone ECU 4 specifying that the updated vehicle power state is a steady state (B306: YES), the first zone ECU 4 cancels the mask of the diagnosis to start the diagnosis and permits the operation of ab application that is operable in the current vehicle power state (B310).

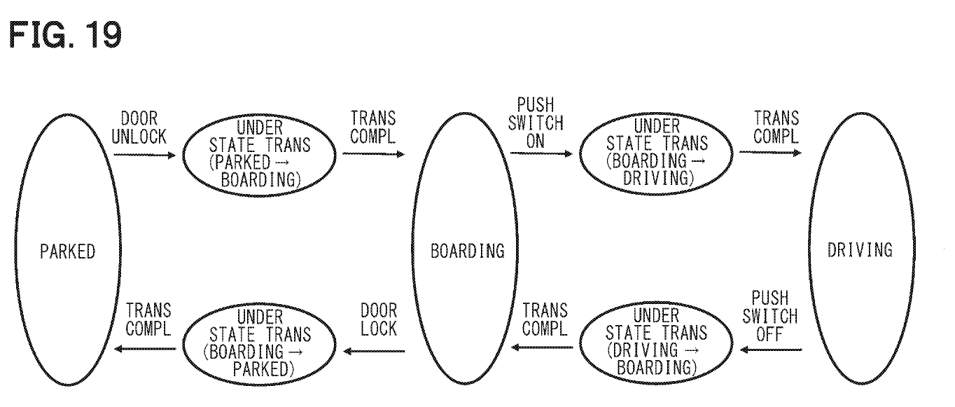

FIG. 19 illustrates the state transitions in the mobility computer 2. The mobility computer 2 transitions the vehicle power state according to the scenes. Upon the mobility computer 2 detecting a door unlock in the "parked" state, the mobility computer 2 transitions to the "under-state-transition” indicating state-transition from “parked” state to “boarding" state. Upon completing the state transition, the mobility computer 2 transitions to the "boarding" state. Upon the mobility computer 2 detecting that the push switch is turned ON while in the "boarding" state, the mobility computer 2 transitions to the "under-state-transition” indicating state-transition from “boarding” to “driving" state. Upon completing the state transition, the mobility computer 2 transitions to the "driving" state. Upon the mobility computer 2 detecting that the push switch is turned OFF while in the "driving" state, the mobility computer 2 transitions to the "under-state-transition” indicating state transition from “driving” to “boarding" state. Upon completing the state transition, the mobility computer 2 transitions to the "boarding" state. Upon the mobility computer 2 detecting door lock in the "boarding" state, the mobility computer 2 transitions to the "under-state-transition” indicating state-transition from “boarding” to “parked" state. Upon completing the state transition, the mobility computer 2 transitions to the "parked" state.

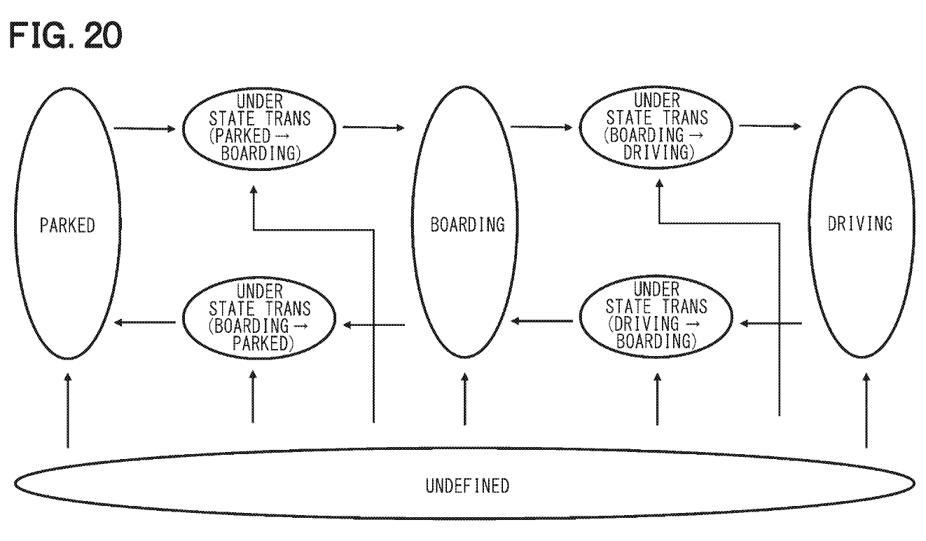

FIG. 20 illustrates the state transitions of the first zone ECU 4, the power distribution management ECU 3, and the end ECUs 6 and 7. Upon receiving the vehicle power state information from the mobility computer 2, each of the first zone ECU 4, the power distribution management ECU 3, and the end ECUs 6 and 7 does state transition based on the received vehicle power state information.

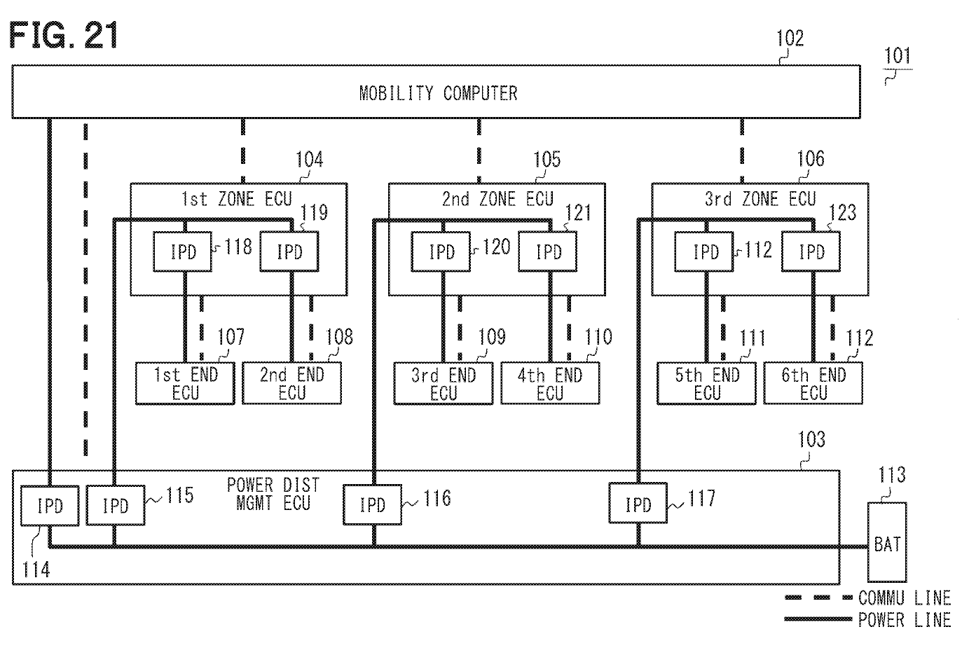

The communication system 1 described above may have various network configurations. The following describes the network configurations with reference to FIGS. 21 to 25. In all of the network configurations illustrated below, the startup stop control based on the aforementioned scenes, the startup stop control by timeout method, and the management of the vehicle power state are performed.

### 1 Star-type connection configuration in which the power distribution management ecu and the zone ecus are separated see FIG. 21

A communication system 101 includes a mobility computer 102 (corresponding to the management device), a power distribution management ECU 103 (corresponding to the power distribution management device), zone ECUs 104 to 106 (corresponding to electronic control units and first electronic control unit), and end ECUs 107 to 112 (corresponding to electronic control units and second electronic control unit). The mobility computer 102 is communicably connected with the power distribution management ECU 103, the first zone ECU 104, the second zone ECU 105, and the third zone ECU 106. The first zone ECU 104 is communicably connected with the first end ECU 107 and the second end ECU 108. The second zone ECU 105 is communicably connected with the third end ECU 109 and the fourth end ECU 110. The third zone ECU 106 is communicably connected with the fifth end ECU 111 and the sixth end ECU 112.

The power distribution management ECU 103 distributes the electric power, supplied from the battery 113, to the mobility computer 102, the zone ECUs 104 to 106, and the end ECUs 107 to 112. The power distribution management ECU 103 always supplies the power to the mobility computer 102 by keeping the IPD 114 always ON. The power distribution management ECU 103 manages power distribution to the first zone ECU 104 by turning ON and OFF the IPD 115, manages power distribution to the second zone ECU 105 by turning ON and OFF the IPD 116, and manages power distribution to the third zone ECU 106 by turning ON and OFF the IPD 117.

The first zone ECU 104 manages power distribution to the first end ECU 107 by turning ON and OFF the IPD 118 and manages power distribution to the second end ECU 108 by turning ON and OFF the IPD 119. The second zone ECU 105 manages power distribution to the third end ECU 109 by turning ON and OFF the IPD 120 and manages power distribution to the fourth end ECU 110 by turning ON and OFF the IPD 121. The third zone ECU 106 manages power distribution to the fifth end ECU 111 by turning ON and OFF the IPD 122 and manages power distribution to the sixth end ECU 112 by turning ON and OFF the IPD 123.

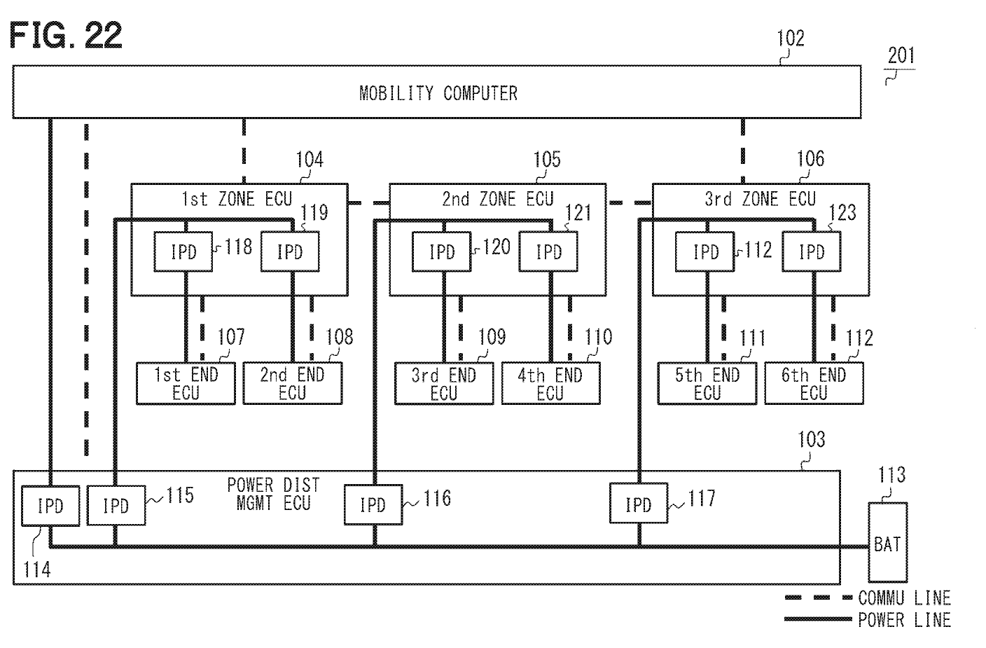

### 2 Ring-type connection configuration in which the power distribution management ECU and the zone ECUs are separated see FIG. 22

A communication system 201 differs from the communication system 101 described in FIG. 21 in that the mobility computer 102 and the zone ECUs 104 to 106 are communicably connected in a ring configuration. The mobility computer 102 communicates with the second zone ECU 105 via the first zone ECU 104 or the third zone ECU 106. Specifically, data transmitted from the mobility computer 102 to the first zone ECU 104 is forwarded from the first zone ECU 104 to the second zone ECU 105. In addition, data transmitted from the mobility computer 102 to the third zone ECU 106 is forwarded from the third zone ECU 106 to the second zone ECU 105.

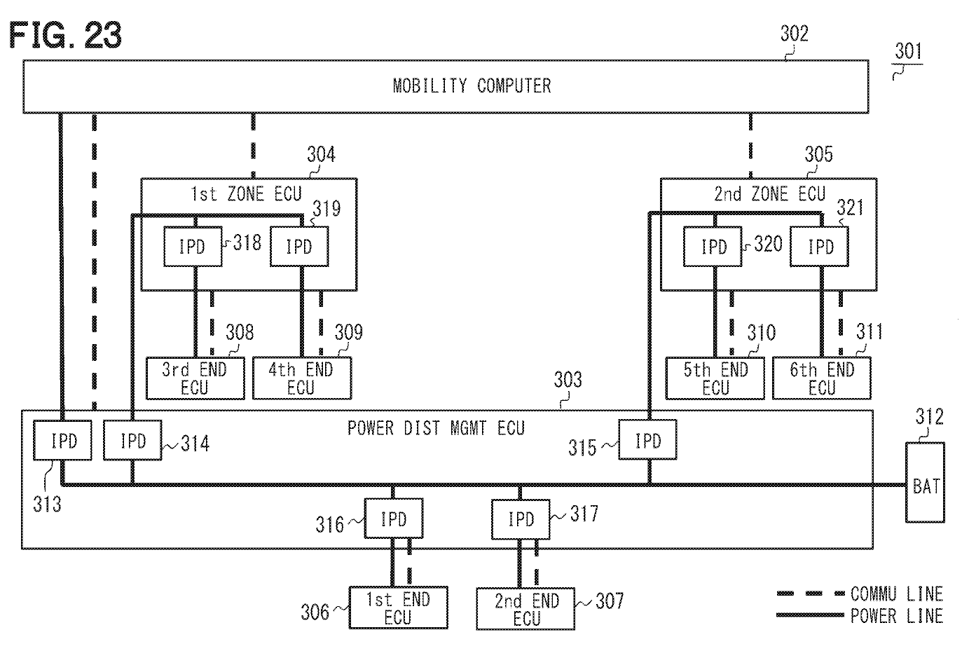

### 3 Star-type connection configuration in which the power distribution management ECU and the zone ECUs are integrated see FIG. 23

A communication system 301 includes a mobility computer 302 (corresponding to a management device), a power distribution management ECU 303 (corresponding to a power distribution management device), zone ECUs 304 and 305 (corresponding to electronic control units and first electronic control units), end ECUs 306 and 307 (corresponding to electronic control units and first electronic control units), and end ECUs 308 to 311 (corresponding to electronic control units and second electronic control units). The power distribution management ECU 303 has a function as a zone ECU that is arranged in a higher level than some end ECUs. The mobility computer 302 is communicably connected with the power distribution management ECU 303, the first zone ECU 304, and the second zone ECU 305. The power distribution management ECU 303 is communicably connected with the first end ECU 306 and the second end ECU 307. The first zone ECU 304 is communicably connected with the third end ECU 308 and the fourth end ECU 309. The second zone ECU 305 is communicably connected with the fifth end ECU 310 and the sixth end ECU 311.

The power distribution management ECU 303 distributes electric power, supplied from the battery 312, to the mobility computer 302, the zone ECUs 304 and 305, and the end ECUs 306 and 307. The power distribution management ECU 303 supplies the power always to the mobility computer 302 by keeping the IPD 313 always ON. The power distribution management ECU 303 controls the supply of the power to the first zone ECU 304 by turning the IPD 314 ON and OFF, controls the supply of the power to the second zone ECU 305 by turning the IPD 315 ON and OFF, controls the supply of the power to the first end ECU 306 by turning the IPD 316 ON and OFF, and controls the supply of the power to the second end ECU 307 by turning the IPD 317 ON and OFF.

The first zone ECU 304 controls the supply of the power to the third end ECU 308 by turning the IPD 318 ON and OFF and controls the supply of the power to the fourth end ECU 309 by turning the IPD 319 ON and OFF. The second zone ECU 305 controls the supply of the power to the fifth end ECU 310 by turning the IPD 320 ON and OFF and controls the supply of the power to the sixth end ECU 311 by turning the IPD 321 ON and OFF.

In a configuration where the end ECUs 306 and 307 are directly connected to the power distribution management ECU 303 and the power distribution management ECU 303 functions as a zone ECU arranged in a higher level than some end ECUs, the mobility computer 302 outputs the IPD-ON signals and the IPD-OFF signals for the IPD 316 corresponding to the first end ECU 306 and the IPD 317 corresponding to the second end ECU 307 to the power distribution management ECU 303, where the first end ECU 306 and the second end ECU 307 are directly connected to the power distribution management ECU 303. The power distribution management ECU 303 turns the IPD 316 ON and OFF based on the ON/OFF instructions for the IPD 316 received from the mobility computer 302, thereby alternating between a power supplying state in which the power is supplied to the first end ECU 306 and a power cutoff state in which the supply of the power to the first end ECU 306 is cut off. The power distribution management ECU 303 turns the IPD 317 ON and OFF based on the ON/OFF instructions for the IPD 317 received from the mobility computer 302, thereby alternating between a power supplying state in which the power is supplied to the first end ECU 307 and a power cutoff state in which the supply of the power to the first end ECU 307 is cut off. It should be noted that FIG. 23 illustrates a configuration in which the end ECUs 306 and 307 are directly connected to the power distribution management ECU 303, but an alternative configuration may be such that all of the end ECUs 306 to 311 are directly connected to the power distribution management ECU 303 and the zone ECUs 304 and 305 are absent. In that case, the IPDs 314 and 315 are absent, and the IPDs corresponding to the IPDs 318 to 321 are arranged in the power distribution management ECU 303.

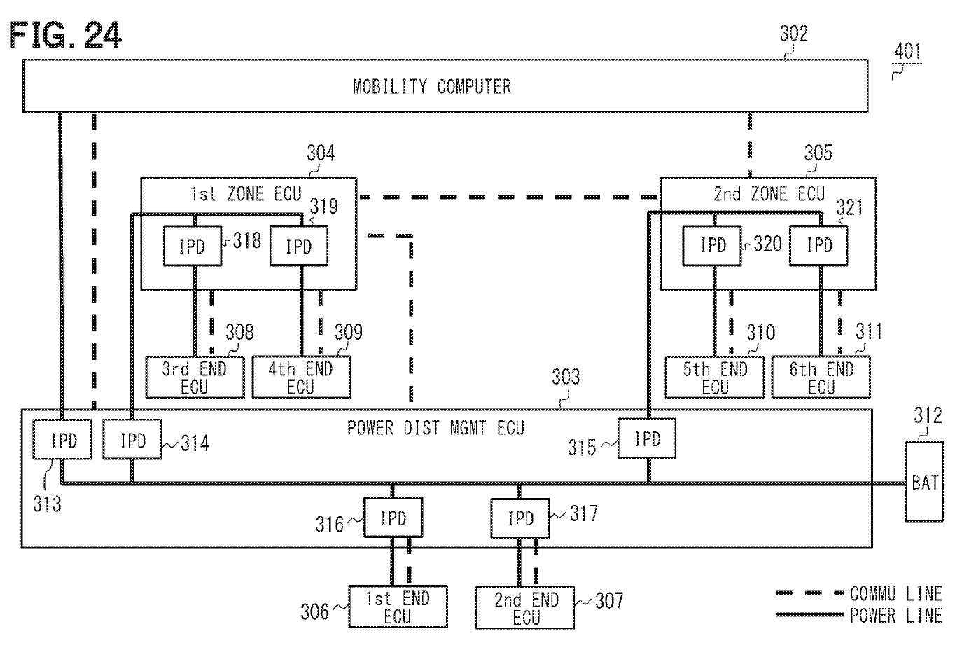

### 4 Ring-type connection configuration in which the power distribution management ECU and the zone ECU are integrated see FIG. 24

A communication system 401 differs from the communication system 301 described in FIG. 23 in that the mobility computer 302, the power distribution management ECU 303, and the zone ECUs 304 and 305 are communicably connected in a ring-type configuration. The mobility computer 302 communicates with the first zone ECU 304 via the power distribution management ECU 303 or the second zone ECU 305. For example, data transmitted from the mobility computer 302 to the power distribution management ECU 303 is forwarded from the power distribution management ECU 303 to the first zone ECU 304. Data transmitted from the mobility computer 302 to the second zone ECU 305 is forwarded from the second zone ECU 305 to the first zone ECU 304. Also, as in FIG. 23, the power distribution management ECU 303 turns the IPD 316 ON and OFF based on the ON/OFF instruction for the IPD 316 from the mobility computer 302, thereby alternating between the power supplying state in which the power is supplied to the first end ECU 306 and the power cutoff state in which the supply of the power to the first end ECU 306 is cut off. In addition, the power distribution management ECU 303 turns the IPD 317 ON and OFF based on the ON/OFF instruction for the IPD 317 from the mobility computer 302, thereby alternating between the power supplying state in which the power is supplied to the first end ECU 307 and the power cutoff state to the first end ECU 307 in which the supply of the power to the first end ECU 307 is cut off.

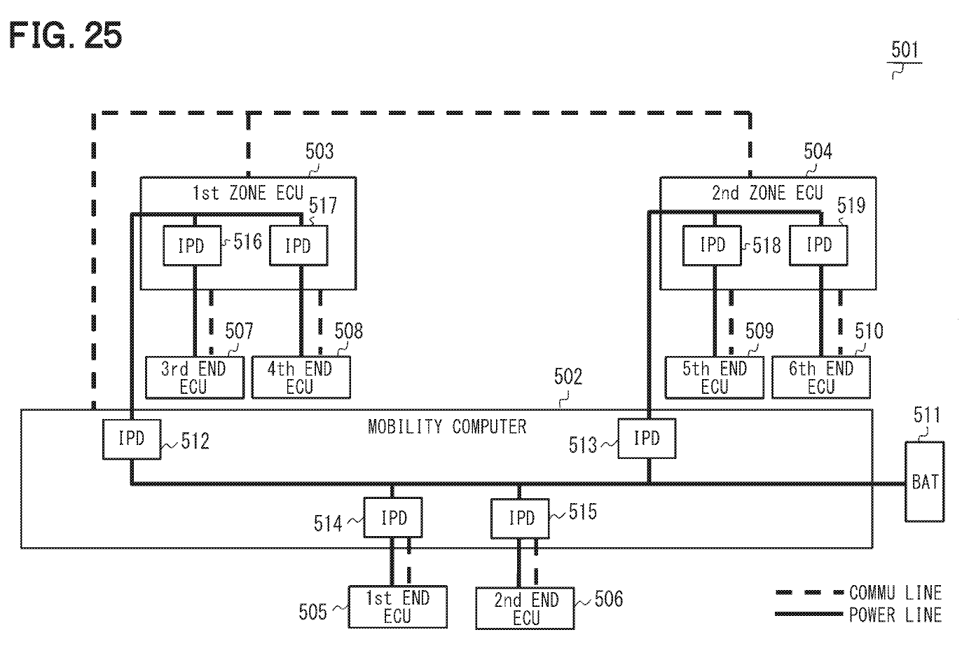

### 5 Connection configuration in which the mobility computer, the power distribution management ECU, and the zone ECU are integrated see FIG. 25

A communication system 501 includes a mobility computer 502 (corresponding to a management device), zone ECUs 503 and 504 (corresponding to electronic control units and first electronic control units), end ECUs 505 and 506 (corresponding to electronic control units and first electronic control units), and end ECUs 507 to 510 (corresponding to electronic control units and second electronic control units). The mobility computer 502 has a function of a power distribution management ECU and a function of a zone ECU arranged in a higher level than some end ECUs. The mobility computer 502 is communicably connected to the first zone ECU 503, the second zone ECU 504, the first end ECU 505, and the second end ECU 506. The first zone ECU 503 is communicably connected to the third end ECU 507 and the fourth end ECU 508. The second zone ECU 504 is communicably connected to the fifth end ECU 509 and the sixth end ECU 510.

The mobility computer 502 is directly connected to the battery 511 and distributes electric power, supplied from the battery 511, to the zone ECUs 503 and 504, as well as to the end ECUs 505 and 506. The mobility computer 502 manages power distribution to the first zone ECU 503 by turning the IPD 512 ON and OFF, manages power distribution to the second zone ECU 504 by turning the IPD 513 ON and OFF, manages power distribution to the first end ECU 505 by turning the IPD 514 ON and OFF, and manages power distribution to the second end ECU 506 by turning the IPD 515 ON and OFF.

The first zone ECU 503 manages power distribution to the third end ECU 507 by turning the IPD 516 ON and OFF and manages power distribution to the fourth end ECU 508 by turning the IPD 517 ON and OFF. The second zone ECU 504 manages power distribution to the fifth end ECU 509 by turning the IPD 518 ON and OFF and manages power distribution to the sixth end ECU 510 by turning the IPD 519 ON and OFF.

In a configuration where the mobility computer 502 is directly connected to the battery 511 and the end ECUs 505 and 506 are directly connected to the mobility computer 502,and the mobility computer 502 has the function of the power distribution management ECU and the function of the zone ECU, the mobility computer 502 by itself manages power distribution to the zone ECUs 503 and 504 as well as to the end ECUs 505 and 506. The mobility computer 502 turns the IPD 512 ON and OFF to alternate between a power supplying state in which the power is supplied to the first zone end ECU 503 and a power cutoff state in which the supply of the power to the first zone ECU 503 is cut off. The mobility computer 502 turns the IPD 513 ON and OFF to alternate between a power supplying state in which the power is supplied to the second zone ECU 504 and a power cutoff state in which the supply of the power to the second zone ECU 504 is cut off. The mobility computer 502 turns the IPD 514 ON and OFF to alternate between a power supplying state in which the power is supplied to the first end ECU 505 and a power cutoff state in which the supply of the power to the first end ECU 505 is cut off. The mobility computer 502 turns the IPD 515 ON and OFF to alternate between a power supplying state in which the power is supplied to the second end ECU 506 and a power cutoff state in which the supply of the power to the second end ECU 506 is cut off. FIG. 25 shows an example in which the end ECUs 505 and 506 are directly connected to the mobility computer 502. An alternative configuration may be such that all of the end ECUs 505 to 510 are directly connected to the mobility computer 502 and the zone ECUs 503 and 504 are absent. In that case, the IPDs 512 and 513 are absent, and the IPDs corresponding to the IPDs 516 to 519 are arranged in the mobility computer 502.

The present embodiment described above provides the following operational effects. The present embodiment is configured such that the power distribution management ECU 3, the zone ECUs 4 and 5, and the end ECUs 6 to 9 set their self-retaining information of the vehicle power state to the undefined state at startup, and upon acquiring the vehicle power state information from the mobility computer 2, update their retaining information of the vehicle power state based on the acquired power state information. Therefore, the present embodiment can appropriately manage the vehicle power state and appropriately perform diagnosis management and/or application operation management at startup and/or under state transition.

The present embodiment is configured such that when the vehicle power state in the self-retaining information is the undefined, the diagnosis concerning the communication lost is not performed. Without managing the diagnosis concerning the communication lost taking into account that it is highly likely that the communication lost occurs at the startup, the present embodiment can prevent management of the unneeded diagnosis concerning the communication lost.

The present embodiment is configured such that the ECU acquires the power state information from the mobility computer 2, and if the acquired power state information indicates the under-state-transition” indicating that the state transition is in progress, the ECU sets the vehicle power state in the self-retaining information to "under-state-transition." The present embodiment can appropriately manage that the vehicle power state is the under-state-transition.

The present embodiment is configured such that when the vehicle power state in the self-retaining information is the under-state-transition, the ECU does not manage the diagnosis concerning the communication lost. Without managing the diagnosis concerning the communication lost taking into account that it is highly likely that the communication lost occurs under the state transition, the present embodiment can prevent management of the unneeded diagnosis concerning the communication lost.

The present embodiment is configured such that the mobility computer 2 determines the vehicle power state and transmits the vehicle power state information indicating the determined vehicle power state to the power distribution management ECU 3 and the zone ECUs 4 and 5 and the zone ECUs 4 and 5 then transmit the vehicle power state information, acquired from the mobility computer 2, to the end ECUs 6 to 9. The present embodiment can relay the vehicle power state information according to the hierarchy.

The present disclosure has been described in accordance with embodiments, but it is understood that the present disclosure is not limited to these embodiments or structures. The present disclosure also encompasses various modifications and alterations within the scope of equivalents. In addition, various combinations and configurations, as well as other combinations or configurations, including only one element, or more or less, are also within the scope and spirit of the present disclosure.

The control units and methods described in the present disclosure may also be implemented by a dedicated computer provided by configuring a processor programmed to execute one or more functions embodied in a computer program in a memory. Alternatively, the control units and methods described in the present disclosure may be implemented by a dedicated computer provided by configuring a processor with one or more dedicated hardware logic circuits. Alternatively, the control units and methods described in the present disclosure may be implemented by one or more dedicated computers provided by configuring a processor programmed to execute one or more functions in combination with one or more hardware logic circuits. Furthermore, the computer program may be stored as instructions executable by a computer on a computer-readable, non-transitory, tangible storage medium.

What is claimed is:

1. A communication system mounted on a movable object, comprising:
a management device implemented by a computer; and
an electronic control unit arranged to be communicable with the management device,
wherein the electronic control unit is configured such that:
the electronic control unit is started up by supply of power from an outside of the electronic control unit via a relay and is stopped by cutoff of the power from the outside via the relay;
the electronic control unit being supplied with the power is started up by switching to a wake-up state and is stopped by switching to a sleep state, based on a communication frame received from the outside;
the electronic control unit retains self-retaining information of a vehicle power state;
at startup, the electronic control unit sets the vehicle power state in the self-retaining information to undefined; and
upon acquiring vehicle power state information from the management device, the electronic control unit updates the vehicle power state in the self-retaining information.

2. The communication system according to claim 1, wherein
the management device is configured to determine the vehicle power state and transmit the vehicle power state information indicating the determined vehicle power state to the electronic control unit.

3. The communication system according to claim 1, wherein
the electronic control unit is configured such that, when the vehicle power state in the self-retaining information is the undefined, the electronic control unit does not manage diagnosis concerning communication lost.

4. The communication system according to claim 1, wherein
the electronic control unit is configured to:
acquire the vehicle power state information from the management device; and
upon the acquired vehicle power state information indicating an under-state-transition indicating that state transition is in progress, set the vehicle power state in the self-retaining information to under-state transition.

5. The communication system according to claim 4, wherein
the electronic control unit is configured such that, when the vehicle power state in the self-retaining information is the under-state-transition, the electronic control unit does not manage diagnosis concerning communication lost.

6. The communication system according to claim 1, wherein
the electronic control unit includes
a first electronic control unit arranged to be directly communicable with the management device, and
a second electronic control unit arranged to be communicable with the management device via the first electronic control unit.

7. The communication system according to claim 6, wherein
the management device is configured to transmit the vehicle power state information to the first electronic control unit, and
the first electronic control unit is configured to transmit to the second electronic control unit the vehicle power state information acquired from the management device.

8. The communication system according to claim 6, further comprising
a power distribution management device implemented by a computer and arranged to be directly communicable with the management device, and configured to manage power distribution to the first electronic control unit and the second electronic control unit.

9. The communication system according to claim 1, wherein
the electronic control unit includes:
a first electronic control unit arranged to be directly communicable with the management device; and
a second electronic control unit arranged to be communicable with the management device via the first electronic control unit, and
the management device has a function of managing power distribution to the first electronic control unit and the second electronic control unit.

10. An electronic control unit in a communication system mounted on a movable object, the electronic control unit being arranged to be communicable with a management device provided by a computer in the communication system,
wherein the electronic control unit is configured such that:
the electronic control unit is started up by supply of power from an outside of the electronic control unit via a relay and is stopped by cutoff of the power from the outside via the relay;
the electronic control unit being supplied with the power is started up by switching to a wake-up state and is stopped by switching to a sleep state, based on a communication frame received from the outside;
the electronic control unit retains self-retaining information of a vehicle power state;
at startup, the electronic control unit sets the vehicle power state in the self-retaining information to undefined; and
upon acquiring vehicle power state information from the management device, the electronic control unit updates the vehicle power state in the self-retaining information.

11. A vehicle power state management method performed in a communication system mounted on a movable object,
the communication system including: a management device implemented by a computer; and an electronic control unit arranged to be communicable with the management device,
the electronic control unit being configured such that:
the electronic control unit is started up by supply of power from an outside of the electronic control unit via a relay and is stopped by cutoff of the power from the outside via the relay; and
the electronic control unit being supplied with the power is started up by switching to a wake-up state and is stopped by switching to a sleep state, based on a communication frame received from the outside,
the vehicle power state management method comprising:
at startup, setting a vehicle power state in self-retaining information to undefined; and
upon acquiring vehicle power state information from the management device, updating the vehicle power state in the self-retaining information.

12. A vehicle power state management program stored in a non-transitory storage medium and executable by a controller of an electronic control unit in a communication system mounted on a movable object, the electronic control unit being arranged to be communicable with a management device implemented by a computer in the communication system,
wherein the electronic control unit is configured such that:
the electronic control unit is started up by supply of power from an outside of the electronic control unit via a relay and is stopped by cutoff of the power from the outside via the relay; and
the electronic control unit being supplied with the power is started up by switching to a wake-up state and is stopped by switching to a sleep state, based on a communication frame received from the outside,
the vehicle power state management program causing the electronic control unit to perform:
at startup, setting a vehicle power state in self-retaining information to undefined; and
upon acquiring vehicle power state information from the management device, updating the vehicle power state in the self-retaining information.
